(19) United States
(12) Patent Application Publication
(10) Pub. No.: US 2024/0362935 A1
(43) Pub. Date: Oct. 31, 2024

(54) AUTOMATIC PROPAGATION OF LABELS BETWEEN SENSOR REPRESENTATIONS FOR AUTONOMOUS SYSTEMS AND APPLICATIONS

(71) Applicant: NVIDIA Corporation, Santa Clara, CA (US)

(72) Inventors: Anton Mitrokhin, Santa Clara, CA (US); Roman Parys, Adliswil (CH); Alexey Solovey, Campbell, CA (US); Tilman Wekel, San Jose, CA (US)

(21) Appl. No.: 18/305,185

(22) Filed: Apr. 21, 2023

Related U.S. Application Data
(63) Continuation of application No. 18/305,153, filed on Apr. 21, 2023.

(51) Int. Cl. G06V 20/70; G06T 7/50

(52) U.S. Cl. CPC G06V 20/70; G06T 7/50

(57) ABSTRACT

In various examples, generating maps using first sensor data and then annotating second sensor data using the maps for autonomous systems and applications is described herein. Systems and methods are disclosed that automatically propagate annotations associated with the first sensor data generated using a first type of sensor, such as a LiDAR sensor, to the second sensor data generated using a second type of sensor, such as an image sensor(s). To propagate the annotations, the first type of sensor data may be used to generate a map, where the map represents the locations of static objects as well as the locations of dynamic objects at various instances in time. The map and annotations associated with the first sensor data may then be used to annotate the second sensor data and/or determine additional information associated with the objects represented by the second sensors data.

### CROSS-REFERENCE TO RELATED APPLICATIONS

This application is a continuation of U.S. patent application Ser. No. 18/305,153, filed Apr. 21, 2023 which is hereby incorporated by reference in its entirety.

### BACKGROUND

Generating annotations for ground truth data is important for many applications, examples of which include training machine learning models and/or analyzing the performance of one or more systems. One technique for generating such annotations includes automatically transferring annotations associated with sensor representations obtained using one sensor, such as a point cloud generated using a LiDAR sensor, to other sensor representations obtained using another sensor, such as images generated using a camera. Performing such automatic transferring of annotations provides numerous advantages, such as improving label quality, increasing labeling throughput, providing additional information (e.g., three-dimensional (3D) information, velocity information, etc.), and reducing costs for generating the annotations.

Current systems use two different techniques for automatically transferring labels between different sensor representations. A first technique includes camera-based depth/occlusion computation, which uses a stereo camera pair, a trained depth prediction neural network, or both a stereo camera pair and a trained depth prediction neural network to transfer labels. Specifically, this first technique transfers annotations for objects depicted by images captured using one camera to the same objects depicted by images captured using another, different camera. However, in practice, this first technique may only work using cameras, and as such, will not transfer annotations associated with other sensor modalities (e.g., LiDAR sensors, radar sensors, ultrasonic sensors, etc.). Additionally, this first technique relies on high quality temporal and spatial synchronization between the cameras.

A second technique includes transferring annotations using LiDAR sensors, such as by transferring annotations associated with a point cloud generated using a LiDAR sensor to images generated using a camera. To transfer annotations using this second technique, 3D mapping and/or local 3D reconstruction is used to recreate the scene using the point cloud. Annotations associated with the point cloud, along with this recreated scene, may then be used to annotate the images. However, the 3D mapping and/or local 3D reconstruction of this second technique does not recreate dynamic objects on the scenes and, as such, this second technique is unable to transfer annotations associated with such dynamic objects from the point cloud to the images. Additionally, the recreated scene is only a single static scan and, as such, is only accurate at the precise moment in time that data for the point cloud was generated.

### SUMMARY

Embodiments of the present disclosure relate to generating maps using a first type of sensor data and propagating annotations to a second type of sensor data using maps for autonomous systems and applications. Systems and methods are disclosed that automatically propagate annotations associated with the first type of sensor data generated using a first type of sensor, such as a point cloud(s) generated using a LiDAR sensor(s), to the second type of sensor data generated using a second type of sensor, such as an image(s) generated using an image sensor(s). To propagate the annotations, the first type of sensor data may be used to generate a map, where the map represents the locations of static objects as well as the locations of dynamic objects at various instances in time. Additionally, annotations associated with the objects may be determined using one or more machine learning techniques (e.g., one or more neural networks) and/or using human input. The map and the annotations may then be used to annotate the second type of sensor data and/or determine additional information associated with the objects represented by the second type of sensors data, such as three-dimensional information (e.g., 3D shapes, depth information, etc.) and/or motion information (e.g., velocities, accelerations, etc.).

In contrast to conventional systems, such as those described above that use the first technique, the current systems, in some embodiments, are able to propagate annotations associated with a first type of sensor data, such as LiDAR data generated using a LiDAR sensor(s), to a second a second type of sensor data, such as image data generated using an image sensor(s) while accurately accounting for differences between spatial and temporal properties between the first type of sensor and the second type of sensor. Additionally, in contrast to the conventional systems, such as those described above that use the second technique, the current systems, in some embodiments, are able to generate map data that represents both the locations of static objects as well as the locations of dynamic objects at various instances in time. As such, the current systems, in some embodiments, may be able to propagate annotations associated with dynamic objects from the first type of sensor data to the second type of sensor data, such as without requiring sensor synchronization. As described above, the conventional systems are unable to propagate such annotations since the maps represent a single static scan that is only accurate at a moment in time and do not represent the locations of dynamic objects.

### BRIEF DESCRIPTION OF THE DRAWINGS

The present systems and methods for generating maps using a first type of sensor data and propagating annotations to a second type of sensor data using maps for autonomous systems and applications are described in detail below with reference to the attached drawing figures, wherein:

FIG. 1 illustrates an example data flow diagram for a process of generating maps using a first type of sensor data and then propagating annotations to a second type of sensor data using the maps, in accordance with some embodiments of the present disclosure;

FIGS. 2A-2B illustrate examples of a vehicle using sensors to generate sensor data, in accordance with some embodiments of the present disclosure;

FIG. 3 illustrates an example of generating annotations associated with objects, in accordance with some embodiments of the present disclosure;

FIGS. 4A-4B illustrate examples of generating maps associated with static objects, in accordance with some embodiments of the present disclosure;

FIG. 5 illustrates an example of tracking dynamic objects over a period of time, in accordance with some embodiments of the present disclosure;

FIGS. 6A-6B illustrate examples of re-inserting dynamic objects into a map, in accordance with some embodiments of the present disclosure;

FIGS. 7A-7B illustrate additional examples of re-inserting dynamic objects into a map, in accordance with some embodiments of the present disclosure;

FIG. 8 illustrates an example of projecting points associated with a map to a sensor representation, in accordance with some embodiments of the present disclosure;

FIG. 9 illustrates an example of annotating a sensor representation, in accordance with some embodiments of the present disclosure;

FIG. 10 illustrates an example of a depth map, in accordance with some embodiments of the present disclosure;

FIG. 11 illustrates an example of updating a depth map, in accordance with some embodiments of the present disclosure;

FIG. 12 is a flow diagram showing a method for generating a map using sensor data, in accordance with some embodiments of the present disclosure;

FIG. 13 is a flow diagram showing a method for propagating an annotation between sensor representations, in accordance with some embodiments of the present disclosure;

FIG. 14 is a flow diagram showing a method for generating a map using first sensor data and then using the map to annotate second sensor data, in accordance with some embodiments of the present disclosure;

FIG. 15A is an illustration of an example autonomous vehicle, in accordance with some embodiments of the present disclosure;

FIG. 15B is an example of camera locations and fields of view for the example autonomous vehicle of FIG. 15A, in accordance with some embodiments of the present disclosure;

FIG. 15C is a block diagram of an example system architecture for the example autonomous vehicle of FIG. 15A, in accordance with some embodiments of the present disclosure;

FIG. 15D is a system diagram for communication between cloud-based server(s) and the example autonomous vehicle of FIG. 15A, in accordance with some embodiments of the present disclosure;

FIG. 16 is a block diagram of an example computing device suitable for use in implementing some embodiments of the present disclosure; and

FIG. 17 is a block diagram of an example data center suitable for use in implementing some embodiments of the present disclosure.

### DETAILED DESCRIPTION

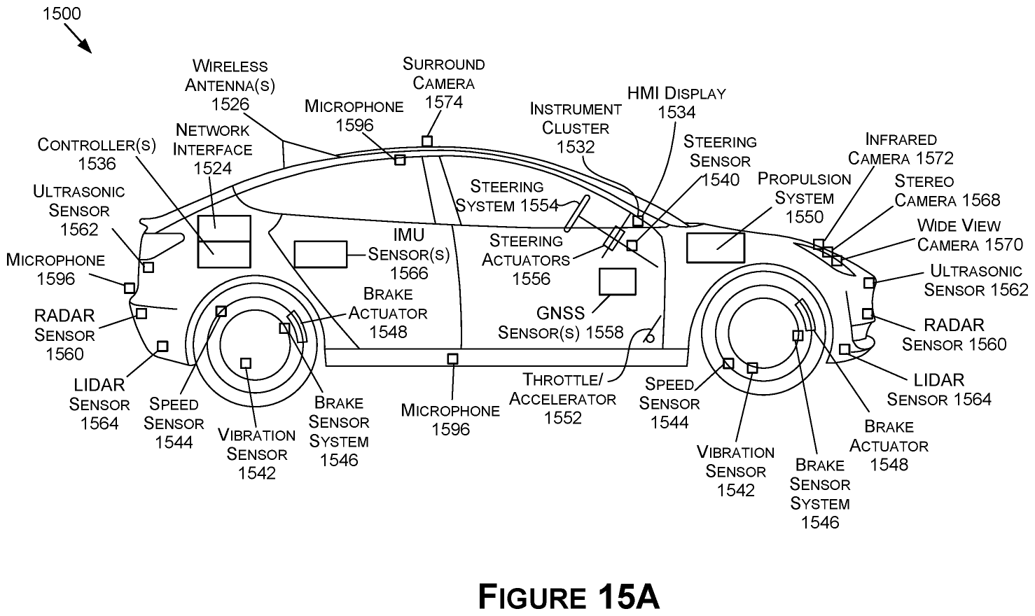

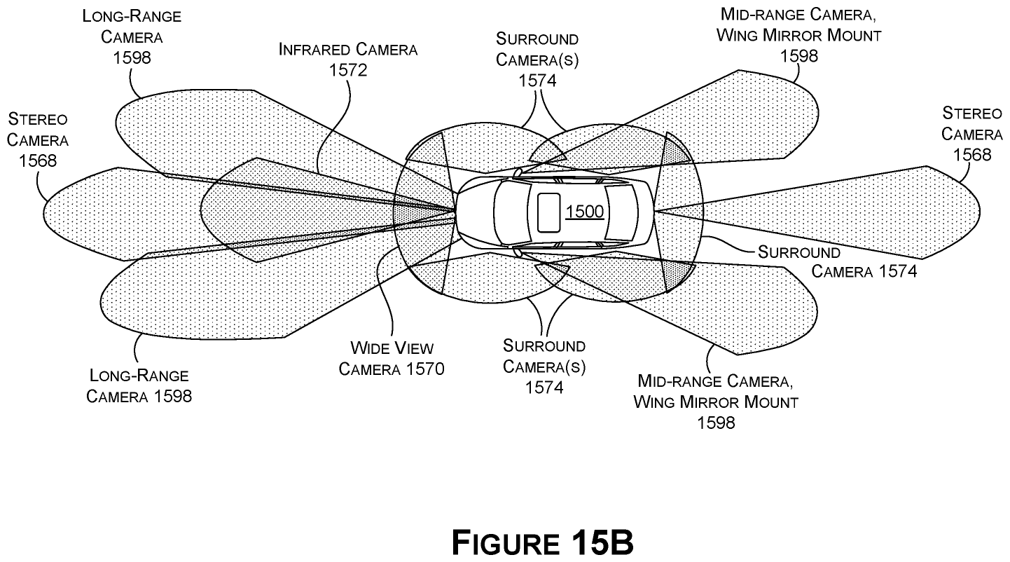

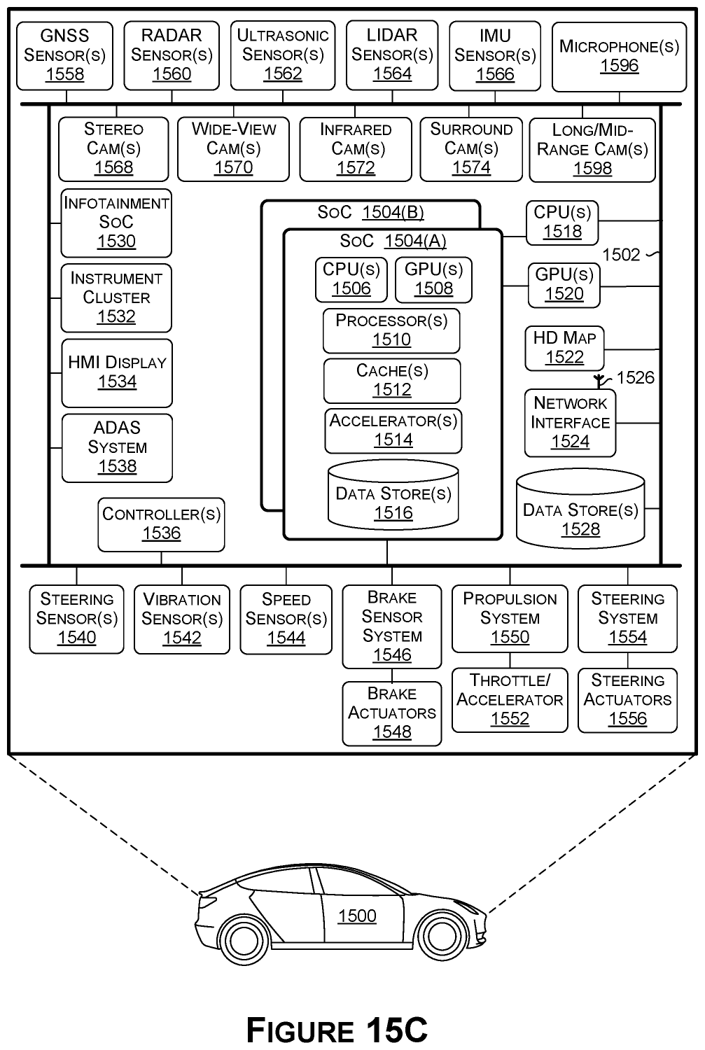

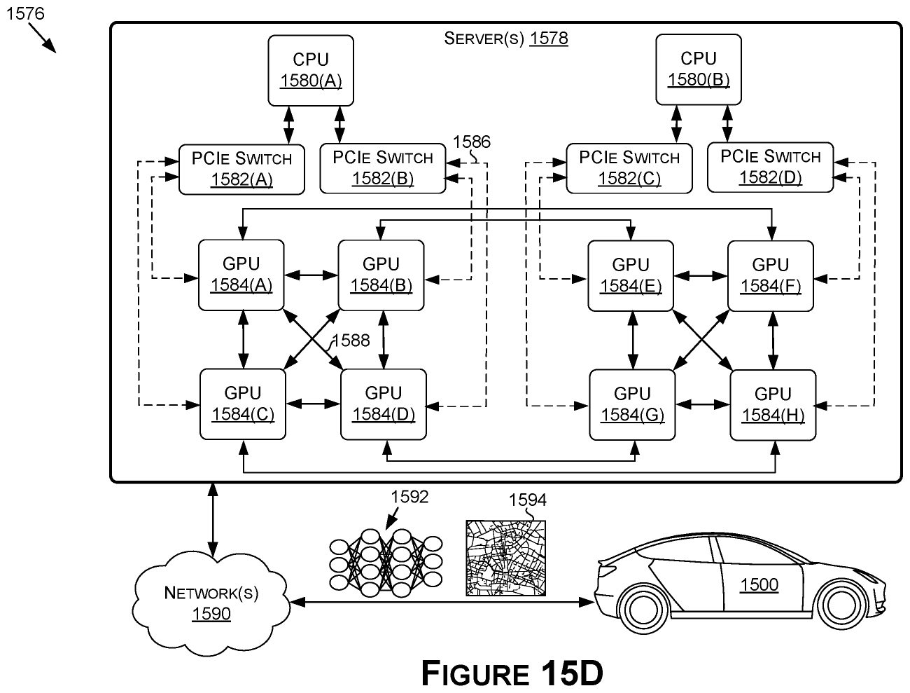

Systems and methods are disclosed related to generating maps using a first type of sensor data and propagating annotations to a second type of sensor data using maps for autonomous systems and applications. Although the present disclosure may be described with respect to an example autonomous vehicle 1500 (alternatively referred to herein as “vehicle 1500” or “ego-vehicle 1500,” an example of which is described with respect to FIGS. 15A-15D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may described with respect to generating maps and/or annotating sensor data, this is not intended to be limiting, and the systems and methods described herein may be used in augmented reality, virtual reality, mixed reality, robotics, security and surveillance, autonomous or semi-autonomous machine applications, and/or any other technology spaces where generating maps and/or annotating sensor data may be used.

For instance, a system(s) may receive first sensor data generated using one or more first sensors of a vehicle and second sensor data generated using one or more second sensors of the vehicle. As described herein, sensor data may include, but is not limited to, image data generated using an image sensor(s), LiDAR data generated using a LiDAR sensor(s), radar data generated using a radar sensor(s), and/or any other type of sensor data generated using any other type of sensor. In some examples, the first sensor data includes a same type of sensor data as the second sensor data. In other examples, the first sensor data includes a different type of sensor data as compared to the second sensor data. For example, the first sensor data may be generated using, or obtained from, a distance type sensor(s), such as a LiDAR sensor, a radar sensor(s), an ultrasonic sensor(s), a stereo camera, a depth camera, and/or the like, while the second sensor data is generated using an image sensor(s), such as a camera(s).

The system(s) may then generate a map using at least the first sensor data generated using the first sensor(s). For instance, the system(s) may identify at least a first portion of the first sensor data that is associated with one or more static objects and a second portion of the first sensor data that is associated with one or more dynamic objects. For instance, the first portion of the first sensor data may include first points from a point cloud that are associated with the static object(s) and the second portion of the first sensor data may include second points from the point cloud that are associated with the dynamic object(s). In some examples, the system(s) determines the portions of the first sensor data using annotations associated with the objects. The annotations may be determined using one or more machine learning models that process the first sensor data and/or using user inputs indicating the annotations associated with the objects. In some examples, the system(s) then updates the first sensor data by removing the second portion of the first sensor data that is associated with the dynamic object(s).

The system(s) may then generate a map that represents a reconstruction of the environment represented by the first sensor data. For instance, the system(s) may initially use the first sensor data (e.g., the updated first sensor data with the second portion removed) to generate the map that includes a three-dimensional (3D) mapping of the environment, where the 3D mapping initially indicates at least the location(s) of the static object(s) within the environment. The system(s) may then use the second portion of the first sensor data to “re-insert” the dynamic object(s) into the map, which is described in more detail here. In some examples, such as when the second sensor(s) includes a LiDAR sensor(s) and the first sensor data represents multiple spins associated with the LiDAR sensor(s), first sensor data associated with multiple spins of the LiDAR sensor(s) may be used to increase the point density of the 3D construction, such as the point density of the static object(s) and/or the dynamic object(s). The map may thus represent a 3D construction indicating both the location(s) of the static object(s) and the location(s) of the dynamic object(s) at various instances in time.

The system(s) may then use the map to perform one or more operations, such as to propagate the annotations for the objects represented by the first sensor data to one or more of the objects represented by the second sensor data. For instance, and for a sensor representation (e.g., an image) of the second sensor data, the system(s) may determine a time associated with the sensor representation. In some examples, such as when the second sensor(s) includes an image sensor(s) with a rolling shutter(s), the time may include a time period between a first time that the image sensor(s) started generating the sensor representation (e.g., generated a first pixel of the image) and a second time that the first sensor(s) finished generating the sensor representation (e.g., generated a last pixel of the image). The system(s) may then determine a portion of the first sensor data that is associated with the time. For instance, and again if the first sensor data includes LiDAR data, the system(s) may determine the portion of the LiDAR data that is associated with the nearest LiDAR sensor(s) spin associated with the time and/or a number of LiDAR sensor(s) spins spatially close to the time.

The system(s) may then use the portion of the first sensor data to generate a map (e.g., using the processes described herein), if the map is not already generated, or a portion of the map that is associated with the portion of the first sensor data. As described herein, in some examples, the portion of the map may be associated with an instance in time, such that the portion of the map indicates the location(s) of the dynamic object(s) within the environment at and/or proximate to the instance in time. In other words, the portion of the map may indicate where the dynamic object(s) was located at the time and/or around the time that the sensor representation of the second sensor data was generated. The system(s) may then perform one or more processes, which are described in more detail herein, to project one or more of the dynamic object(s) from the map onto the sensor representation. For instance, if the sensor representation includes an image that depicts a dynamic object, the system(s) may project the points from the map that are associated with the dynamic object to the image (e.g., to pixels of the image).

The system(s) may then generate information associated with the sensor representation for the dynamic object. For a first example, since one or more of the objects represented by the first sensor data and/or the map may be annotated, the system(s) may use the annotation associated with the dynamic object to annotate the dynamic object as represented by the sensor representation. In some examples, the system(s) may associate the portion of the sensor representation (e.g., the pixels of the image) with the annotation and/or the system(s) may generate and then annotate a bounding shape associated with the dynamic object. For a second example, and since the map also includes depth information associated with the one or more objects, the system(s) may associate the depth information with the dynamic object as represented by the sensor representation. For instance, the depth information may indicate one or more depth values associated with one or more points (e.g., pixels) of the sensor representation that depict the dynamic object.

In some examples, such as because the map data represents both the location(s) of the static object(s) and the location(s) of dynamic object(s), the system(s) may use the map to determine occlusion information associated with one or more objects depicted by the sensor representation. For example, the system(s) may determine that at least a portion of a first object and at least a portion of a second object are associated with a same portion (e.g., one or more same pixels) of the sensor representation. As such, the system(s) may use first depth information associated with the first object and second depth information associated with the second object to determine whether the first object is at least partially occluded by the second object or whether the second object is at least partially occluded by the first object. For a first example, the system(s) may determine that the first object is at least partially occluded by the second object when the first depth information includes one or more first depth values that are greater than one or more second depth values included in the second depth information. For a second example, the system(s) may determine that the second object is at least partially occluded by the first object when the second depth information includes one or more second depth values that are greater than one or more first depth values included in the first depth information.

The system(s) may then perform one or more processes based on the occlusion determination. For example, the system(s) may use the occlusion determination when annotating the first object and the second object, such that a first portion (e.g., first pixels) of the sensor representation that is only associated with the first object includes a first annotation associated with the first object, a second portion (e.g., second pixels) of the sensor representation that is only associated with the second object includes a second annotation associated with the second object, and a third portion (e.g., third pixels) of the sensor representation that is associated with the occlusion determination includes the first annotation when the first object occludes the second object or the second annotation when the second object occludes the first object. In other words, the system(s) may annotate the sensor representation such that the sensor representation indicates the occlusion.

In some examples, the system(s) may use the sensor representation and/or the map data to update a depth map associated with the sensor representation. For instance, and as described herein, the system(s) may use the map data to determine depth information (e.g., depth values) associated with points (e.g., pixels) of the sensor representation. However, in some examples, the first sensor(s) may include a first sampling resolution and the second sensor(s) may include a second sampling resolution, where the second sampling resolution is greater than the first sampling resolution. As such, and for an object depicted by the sensor representation, such as an object that is located proximate (e.g., within a threshold distance) to the vehicle, a portion of the points (e.g., pixels) associated with the object may not include depth information (e.g., depth values).

Because of this, the system(s) may process the sensor representation and, based at least on the processing, determine the points of the sensor representation that are associated with the object. In some examples, the processing may include performing surface reconstruction on the sensor representation. The system(s) may then use a first portion of the points that are already associated with depth information to generate depth information associated with a second portion of the points that are not already associated with depth information. For instance, the system(s) may determine that the depth information associated with the second portion of the points is similar to the depth information associated with the first portion of the points.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI, generative AI using language models, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for implementing one or more large language models, systems implemented at least partially in a data center, systems for performing conversational AI operations, systems for performing light transport simulation, systems for performing collaborative content creation for 3D assets, systems implemented using one or more language models, systems implemented at least partially using cloud computing resources, and/or other types of systems.

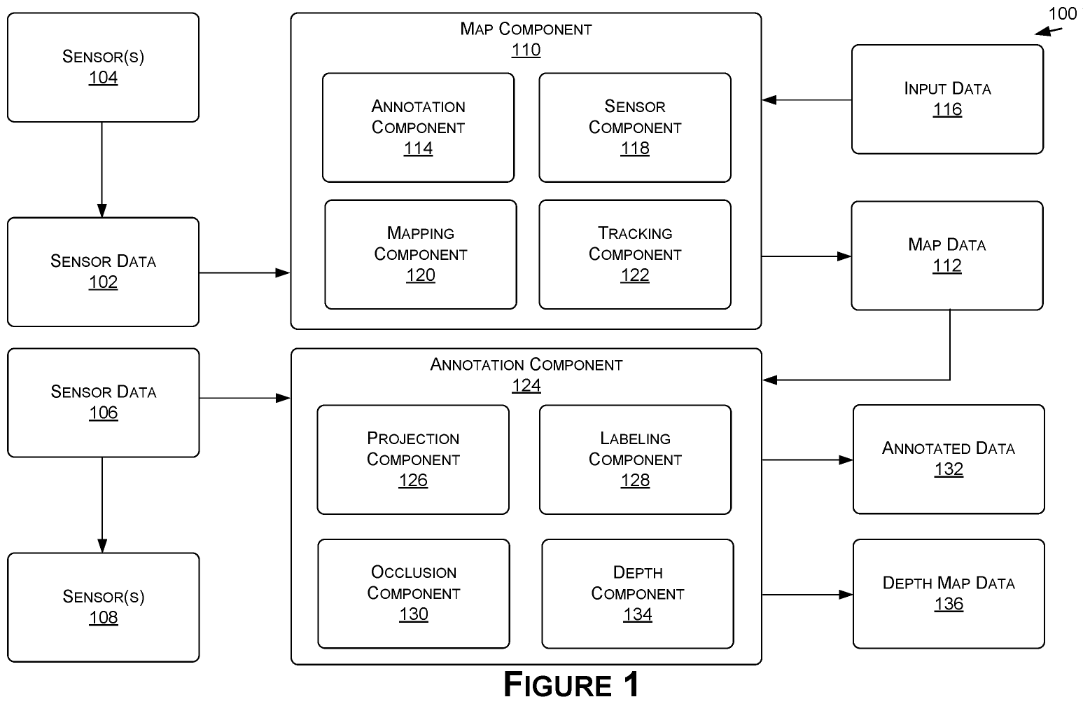

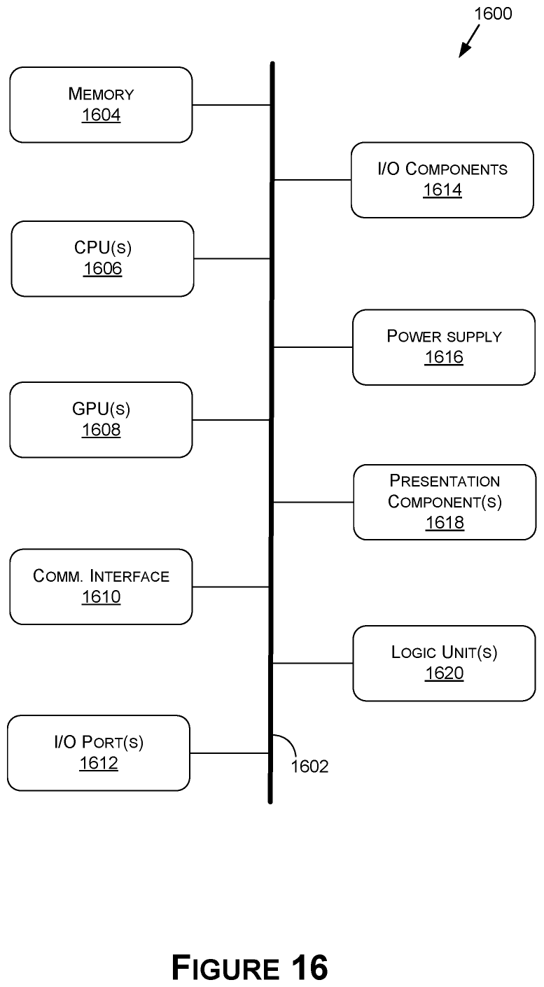

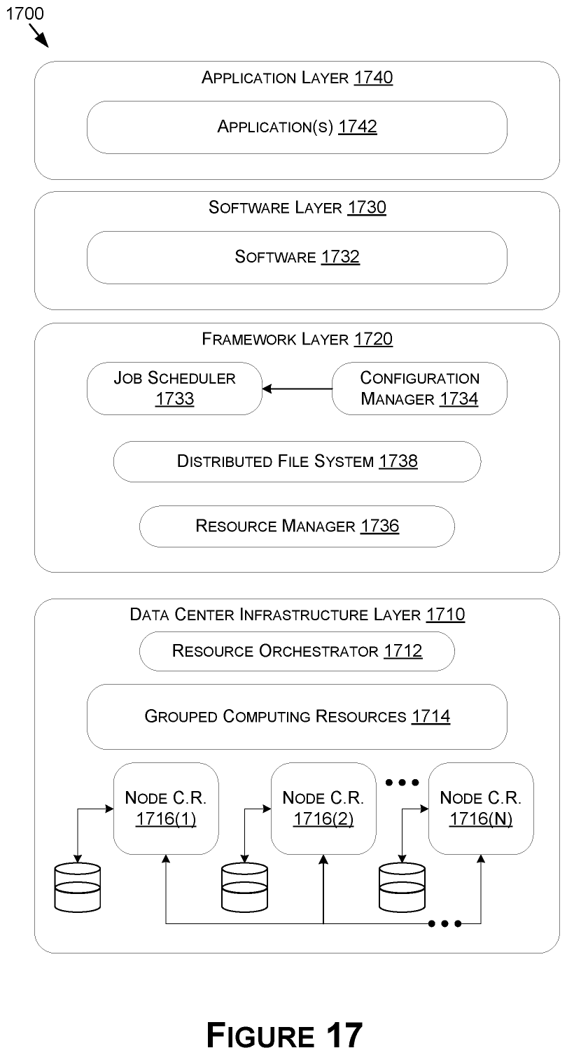

With reference to FIG. 1, FIG. 1 illustrates an example data flow diagram for a process 100 of generating maps using a first type of sensor data and then propagating annotations to a second type of sensor data using the maps, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1500 of FIGS. 15A-15D, example computing device 1600 of FIG. 16, and/or example data center 1700 of FIG. 17.

The process 100 may include receiving first sensor data 102 generated using one or more first sensors 104 and second sensor data 106 generated using one or more second sensors 108. As described herein, sensor data may include, but is not limited to, image data generated using an image sensor(s), LiDAR data generated using a LiDAR sensor(s), radar data generated using a radar sensor(s), and/or any other type of sensor data generated using any other type (e.g., modality) of sensor. In some examples, the first sensor data 102 includes a same type of sensor data as the second sensor data 106. In other examples, the first sensor data 102 includes a different type of sensor data as compared to the second sensor data 106. For example, the first sensor data 102 may be generated using a distance type sensor(s), such as a LiDAR sensor, a radar sensor(s), and/or the like, while the second sensor data 106 is generated using an image sensor(s), such as a camera(s).

In some examples, and as described in more detail herein, the first sensor(s) 104 may include a first rolling shutter and/or the second sensor(s) 108 may include a second rolling shutter. For example, if the first sensor(s) 104 includes a LiDAR sensor(s) and the second sensor(s) 108 includes an image sensor(s), then the first sensor(s) 104 may take a first period of time (e.g., 10 milliseconds, 100 milliseconds, 200 milliseconds, etc.) to perform a complete rotation and the second sensor(s) 108 may take a second period of time (e.g., 10 milliseconds, 30 milliseconds, 100 milliseconds, etc.) to generate an image. Additionally, in some examples, and as also described in more detail herein, the first sensor(s) 104 may include a first sampling resolution and the second sensor(s) 108 may include a second sampling resolution. In such examples, the first sampling resolution may be less than the second sampling resolution, the first sampling resolution may be equal to the second sampling resolution, or the first sampling resolution may be greater than the second sampling resolution.

In some examples, the first sensor(s) 104 and the second sensor(s) 108 may be located on a machine, such as a vehicle. As such, at least a portion of a field-of-view (FOV(s)) of the second sensor(s) 108 may at least partially overlap with at least a portion of the FOV(s) of the first sensor(s) 104. For example, if the first sensor data 102 generated using the first sensor(s) 104 represents an environment surrounding the vehicle (e.g., the first sensor(s) 104 spins while generating the first sensor data 102), then the second sensor data 106 may represent at least a portion of the environment. As such, if the first sensor data 102 represents objects (e.g., static objects and/or dynamic objects) located around the vehicle, then a sensor representation (e.g., an image) represented by the second sensor data 106 may depict one or more of the objects.

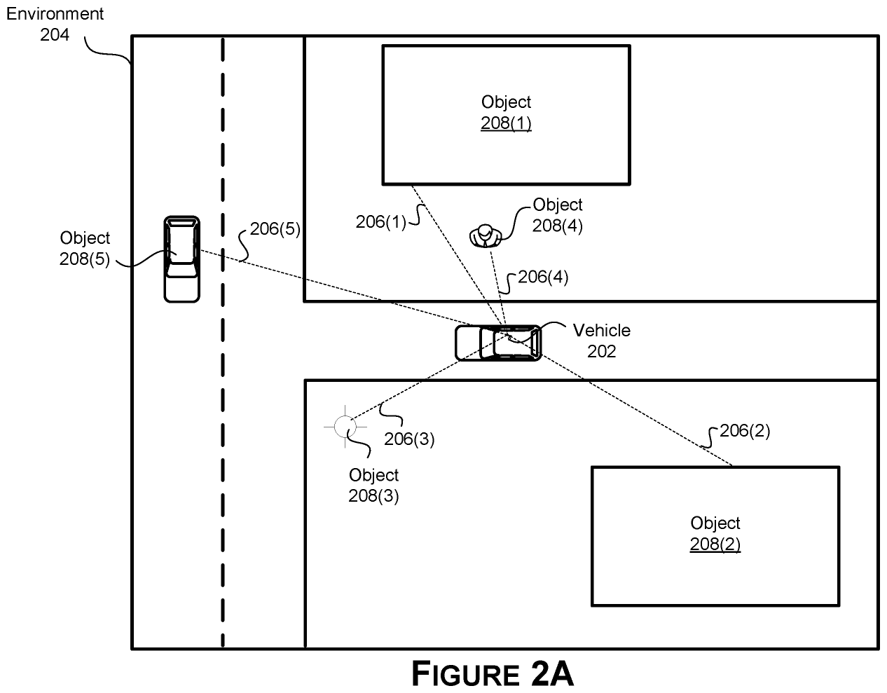

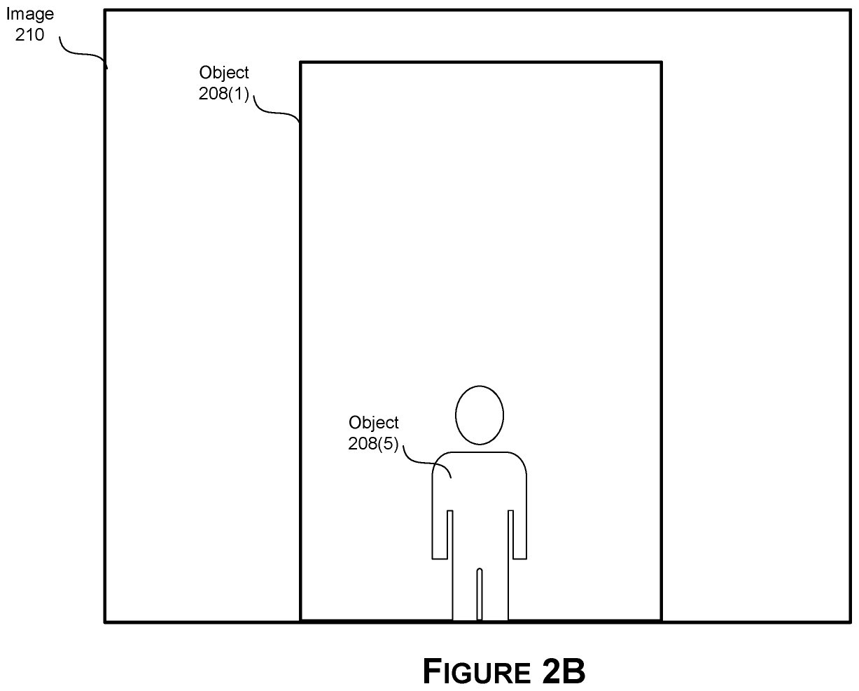

For instance, FIG. 2A illustrates an example of a vehicle 202 using one or more first sensors (e.g., the first sensor(s) 104) to generate first sensor data (e.g., the first sensor data 102), in accordance with some embodiments of the present disclosure. As shown, while the vehicle 202 is navigating around an environment 204, the vehicle 202 may use the first sensor(s) to generate the first sensor data. In the example of FIG. 2A, the first sensor(s) may include a LiDAR sensor(s), where the LiDAR sensor(s) generates the first sensor data by rotating around and detecting distances to points within the environment. For instance, the first sensor data may represent at least one or more first distances to one or more first points associated with a static object 208(1), where the first distance(s) to the first point(s) is represented by 206(1) (although only one is labeled for clarity reasons), one or more second distances to one or more second points associated with a static object 208(2), where the second distance(s) to the second point(s) is represented by 206(2) (although only one is labeled for clarity reasons), one or more third distances to one or more third points associated with a static object 208(3), where the third distance(s) to the third point(s) is represented by 206(3) (although only one is labeled for clarity reasons), one or more fourth distances to one or more fourth points associated with a dynamic object 208(4), where the fourth distance(s) to the fourth point(s) is represented by 206(4) (although only one is labeled for clarity reasons), and one or more fifth distances to one or more fifth points associated with a dynamic object 208(5), where the fifth distance(s) to the fifth point(s) is represented by 206(5) (although only one is labeled for clarity reasons),

In some examples, since the first sensor(s) is rotating when generating the first sensor data, the points associated with the environment 204 may also be associated with timestamps indicating when the points were generated. For example, the first point(s) associated with the static object 208(1) may be associated with a first timestamp(s) indicating a first time(s) that the first point(s) was generated, the second point(s) associated with the static object 208(2) may be associated with a second timestamp(s) indicating a second time(s) that the second point(s) was generated, the third point(s) associated with the static object 208(3) may be associated with a third timestamp(s) indicating a third time(s) that the third point(s) was generated, and/or so forth. While the example of FIG. 2A illustrates the first sensor(s) as determining the distances to five points, in other examples, the first sensor(s) may determine the distances to any number of points (e.g., one point, one hundred points, one thousand points, etc.) using any number of spins.

FIG. 2B illustrates an example of the vehicle 202 using one or more second sensors (e.g., the second sensor(s) 108) to generate second sensor data (e.g., the second sensor data 106), in accordance with some embodiments of the present disclosure. In the example of FIG. 2B, the second sensor(s) may include an image sensor(s) that generates image data representing at least an image 210. As shown, the image 210 depicts at least the static object 208(1) and the dynamic object 208(4) located within the environment 204. In other words, the second sensor(s) used to generate the second sensor data from the example of FIG. 2B includes a FOV(s) that at least partially overlaps with the FOV(s) of the first sensor(s) used to generate the first sensor data from the example of FIG. 2A.

Referring back to the example of FIG. 1, the process 100 may include using a map component 110 to generate a map based at least on the first sensor data 102, where the map may be represented by map data 112. For instance, and as shown, to generate the map, the process 100 may include the map component 110 using an annotation component 114 to generate annotations associated with the objects represented by the first sensor data 102. In some examples, to generate the annotations, the annotation component 114 may include one or more machine learning models that are trained to process the first sensor data 102 and, based at least on the processing, generate the annotations associated with the objects. In such examples, the machine learning model(s) is not restricted to any particular machine learning model architecture or neural network structure and may comprise, for example and without limitation, a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, one or more neural networks (e.g., auto-encoders, convolutional, recurrent, perceptrons, Long/Short Term Memory (LSTM), Hopfield, Boltzmann, deep belief, deconvolutional, generative adversarial, and/or liquid state machine, etc.), and/or other types of machine learning models.

Additionally, or alternatively, in some examples, the annotation component 114 may use input data 116 to generate the annotations associated with the objects. For instance, the input data 116 may represent inputs received by one or more computing devices, such as from one or more users, that indicate the annotations associated with the objects (e.g., the objects may be human labeled). The annotation component 114 may thus use the input data 116 to associate the various annotations with the objects. In any of these examples, an annotation may indicate a classification associated with an object such as, but not limited to, person, vehicle, animal, structure, street sign, a speed limit sign, stop sign, and/or any other type of classification that may be associated with an object.

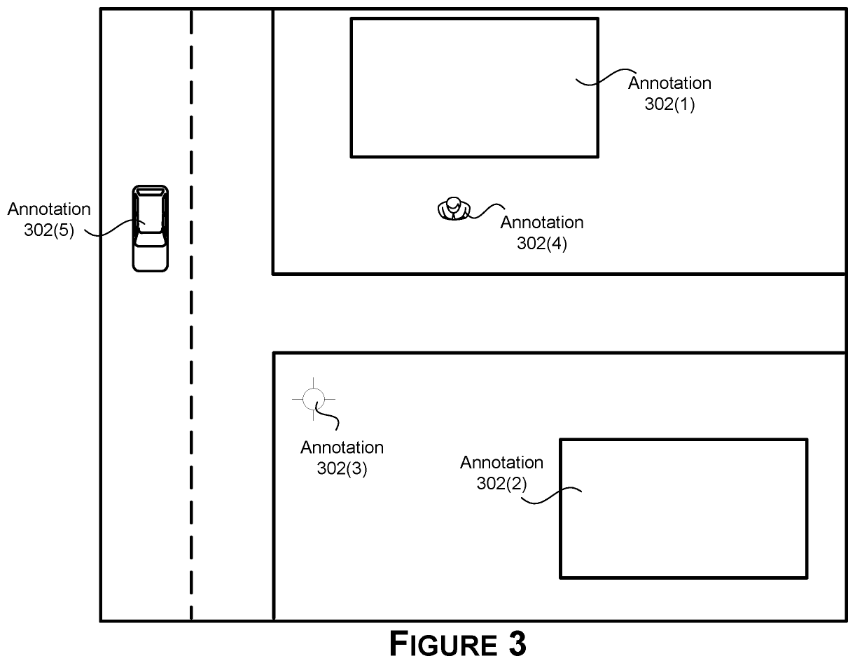

For instance, FIG. 3 illustrates an example of generating annotations associated with objects, in accordance with some embodiments of the present disclosure. In the example of FIG. 3, the annotation component 114 may perform one or more of the processes described herein (e.g., using a machine learning model(s), using input data, etc.) to determine at least a first annotation 302(1) associated with the static object 208(1), a second annotation 302(2) associated with the static object 208(2), a third annotation 302(3) associated with the static object 208(3), a fourth annotation 302(4) associated with the dynamic object 208(4), and a fifth annotation 302(5) associated with the dynamic object 208(5). In the example of FIG. 3, the first annotation 302(1) may indicate a structure, the second annotation 302(2) may indicate a structure, the third annotation 302(3) may indicate a street sign (and/or a type of the street sign), the fourth annotation 302(4) may indicate a pedestrian, and the fifth annotation 302(5) may indicate a vehicle.

Referring back to the example of FIG. 1, the process 100 may include the map component 110 using a sensor component 118 to determine at least a first portion of the first sensor data 102 that is associated with the static objects and a second portion of the first sensor data 102 that is associated with the dynamic objects. For example, such as when the first sensor data 102 represents a point cloud, the sensor component 118 may determine first points from the point cloud that are associated with the static objects and second points from the point cloud that are associated with the dynamic objects. In some examples, the sensor component 118 may use the annotations associated with the objects to determine the portions of the first sensor data 102. Additionally, or alternatively, in some examples, the sensor component 118 may use characteristics associated with the first sensor data 102 to determine the portions of the first sensor data 102. For example, and again if the first sensor data 102 represents the point cloud, the sensor component 118 may process the point cloud over a period of time in order to determine points associated with objects that are not moving (e.g., static objects) and points associated with objects that are moving (e.g., dynamic objects).

In some examples, the sensor component 118 may then further process the first sensor data 102 based on the first portion of the first sensor data 102 that is associated with the static objects and the second portion of the first sensor data 102 that is associated with the dynamic objects. For instance, the sensor component 118 may update the first sensor data 102 by removing at least the second portion of the first sensor data 102 that is associated with the dynamic objects. For example, and again if the first sensor data 102 represents the point cloud, the sensor component 118 may remove at least a portion of the points that are associated the dynamic objects from the point cloud. As such, after updating the first sensor data 102, the updated sensor data 102 may mostly and/or only represent the static objects within the environment.

For instance, and referring back to the example of FIG. 2A, the sensor component 118 may determine that the first point(s) (e.g., represented by 206(1)) are associated with the static object 208(1), the second point(s) (e.g., represented by 206(2)) are associated with the static object 208(2), the third point(s) (e.g., represented by 206(3)) are associated with the static object 208(3), the fourth point(s) (e.g., represented by 206(4)) are associated with the dynamic object 208(4), and the fifth point(s) (e.g., represented by 206(5)) are associated with the dynamic object 208(5). In some examples, the sensor component 118 makes these determinations using at least the annotations 302(1)-(5) associated with the objects 208(1)-(5), respectively. In some examples, the sensor component 118 may then update the first sensor data by removing at least the fourth point(s) associated with the dynamic object 208(4) and the fifth point(s) associated with the dynamic object 208(5).

Referring back to the example of FIG. 1, the process 100 may include the map component 110 using a mapping component 120 to generate a map based at least on the first sensor data 102. For example, the mapping component 120 may initially use the first portion of the first sensor data 102 (e.g., the updated first sensor data 102) to generate the map, where the map initially represents information associated with the static objects within the environment. As described herein, the information may include, but is not limited to, locations of the static objects (e.g., the x-coordinates, the y-coordinates, and/or the z-coordinates associated with the static objects), shapes of the static objects, three-dimensional bounding shapes (e.g., cuboids) representing the static objects, distances to the static objects (e.g., depth values to points associated with the static objects), and/or any other information. In other words, the mapping component 120 may use the first sensor data 102 to create a three-dimensional (3D) reconstruction of the static objects around the vehicle.

In some examples, the mapping component 120 may perform one or more additional processes in order to improve the initial map of the static objects. For instance, and as described herein, the first sensor(s) 104 may generate the first sensor data 102 while spinning such that the first sensor data 102 represents the static objects during multiple spins. As such, the mapping component 120 may use the first sensor data 102 generated over a period of time (e.g., over multiple spins) to better recreate the static objects when generating map. For example, and again if the first sensor data 102 represents a point cloud(s), the mapping component 120 may use the points from the point cloud(s) that are associated with multiple spins of the LiDAR sensor(s) to increase the density of the points associated with the static objects. This may improve the map as compared to using points associated with a single spin of the LiDAR sensor(s) since using just a single spin may reduce the density of the points associated with the static objects.

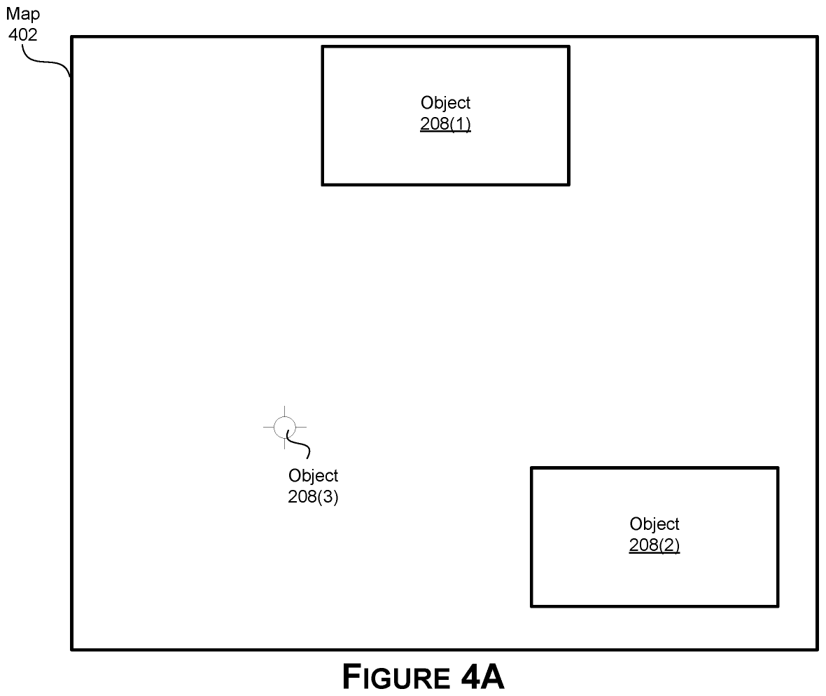

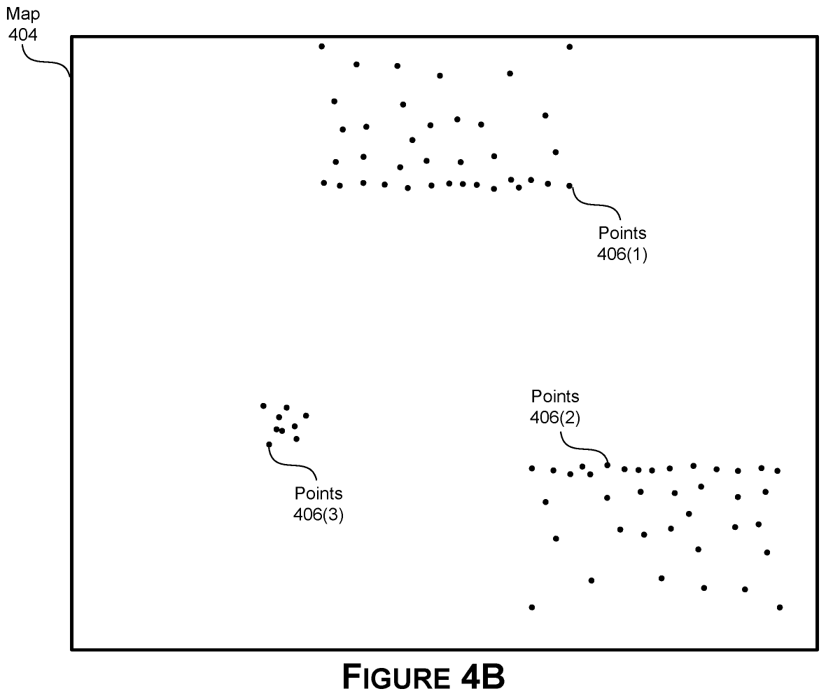

For instance, FIGS. 4A-4B illustrate examples of generating maps associated with static objects, in accordance with some embodiments of the present disclosure. As shown by the example of FIG. 4A, the mapping component 120 may use the first sensor data to generate a map 402 representing at least the locations of the static objects 208(1)-(3) within the environment 204. In some examples, the mapping component 120 generates the map 402 using the first point(s) associated with the static object 208(1), the second point(s) associated with the static object 208(2), and the third point(s) associated with the static object 208(3) from the point cloud(s) represented by the first sensor data. Additionally, as further illustrated in the example of FIG. 4A, the map 402 does not include information associated with the dynamic objects 208(4)-(5).

Next, and as shown by the example of FIG. 4B, the mapping component 120 may use the first sensor data to generate a different type of map 404 that represents the points associated with the static objects 208(1)-(3). For instance, and as shown, the map 404 may represent locations of points 406(1) (although only one is labeled for clarity reasons) associated with the static object 208(1), locations of points 406(2) (although only one is labeled for clarity reasons) associated with the static object 208(2), and locations of points 406(3) (although only one is labeled for clarity reasons) associated with the static object 208(3). As described herein, the points 406(1)-(3) on the map 404 may be associated with information, such as annotations (e.g., labels) associated with the static objects 208(1)-(3), distances to the points 406(1)-(3), timestamps indicating times that the points 406(1)-(3) were generated using the first sensor(s), and/or any other information.

Referring back to the example of FIG. 1, the process 100 may include the map component 110 using a tracking component 122 to track one or more objects, such as one or more of the dynamic objects. For instance, and for a dynamic object, the first sensor(s) 104 may generate the first sensor data 102 representing multiple instances of the dynamic object. For example, if the first sensor(s) 104 include a LiDAR sensor(s), then the first sensor(s) 104 may generate point clouds that include points associated with the dynamic object during various spins associated with the first sensor(s) 104. The tracking component 122 may then use the first sensor data 102 representing the multiple instances of the dynamic object to track the dynamic object over a period of time, such as while the first sensor data 102 represents the dynamic object.

For example, a first point cloud represented by the first sensor data 102 (e.g., a first instance of the first sensor data 102) may represent the dynamic object at a first location at a first time, a second point cloud represented by the first sensor data 102 (e.g., a second instance of the first sensor data 102) may represent the dynamic object at a second location at a second time, a third point cloud represented by the first sensor data 102 (e.g., a third instance of the first sensor data 102) may represent the dynamic object at a third location at a third time, and/or so forth. As such, the tracking component 122 may use the annotations associated with the point clouds of the first sensor data 102 to identify the points from the point clouds that are associated with the dynamic object. The tracking component 122 may then use the points from the point clouds to generate a track for the dynamic object over the period of time.

In some examples, the tracking component 122 may perform one or more additional processes in order to improve the tracking of the dynamic object. For instance, the tracking component 122 may use one or more algorithms, such as an iterative closest point (ICP) algorithm, to reconstruct the 3D surface associated with the dynamic object. For example, and again as described herein, if the first sensor(s) 104 includes the LiDAR sensor(s) that generates multiple points clouds that include points associated with the dynamic object (e.g., with various spins), then the tracking component 122 may use the algorithm(s) to minimize the differences between the point clouds (e.g., by transforming one or more of the points clouds to a fixed point cloud) in order to reconstruct the 3D surface of the dynamic object over the period of time. The tracking component 122 may then perform similar processes to track one or more additional dynamic objects within the environment and/or to reconstruct one or more surfaces associated with the additional dynamic object(s).

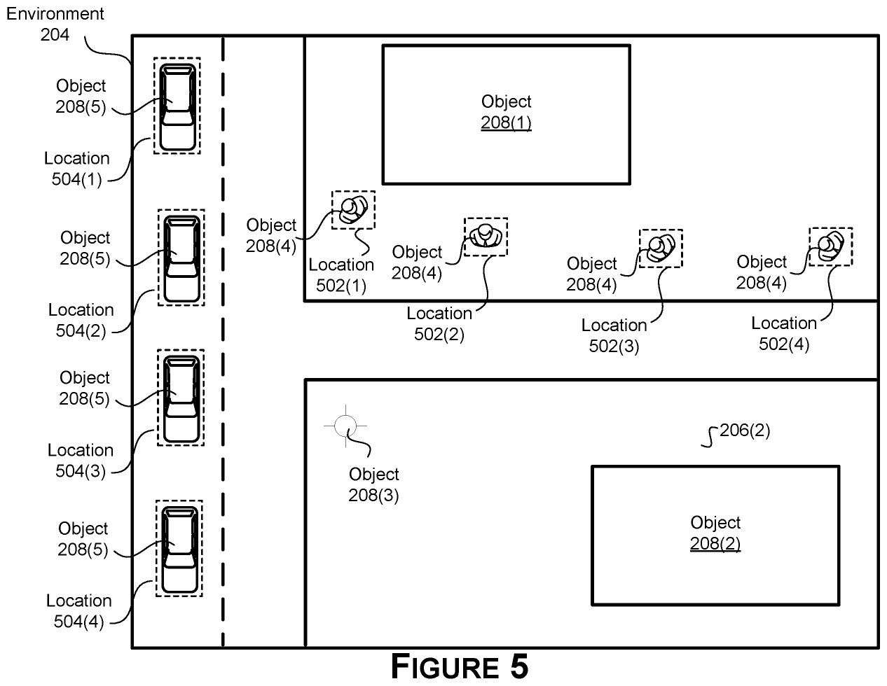

For instance, FIG. 5 illustrates an example of tracking dynamic objects over a period of time, in accordance with some embodiments of the present disclosure. As shown, the tracking component 122 may perform one or more of the processes described herein to track the dynamic object 208(4) as the dynamic object 208(4) moves throughout the environment 204. For example, the tracking component 122 may determine that the dynamic object 208(4) was located at a first location 502(1) at a first time, a second location 502(2) at a second time, a third location 502(3) at a third time, and a fourth location 502(4) at a fourth time. In some examples, the tracking component 122 may use different iterations of the first sensor data to determine the locations 502(1)-(4) of the dynamic object 208(4). For example, if the first sensor(s) includes a LiDAR sensor(s), the mapping component 120 may use a first point cloud to determine the first location 502(1) of the dynamic object 208(4), a second point cloud to determine the second location 502(2) of the dynamic object 208(4), a third point cloud to determine the third location 502(3) of the dynamic object 208(4), and a fourth point cloud to determine the fourth location 502(4) of the dynamic object 208(4).

Additionally, or alternatively, in some examples, the mapping component 120 may use interpolation to determine one or more of the locations 502(1)-(4) associated with the dynamic object 208(4). For example, the mapping component 120 may process a first point cloud to determine the second location 502(2) of the dynamic object 208(4) and a second point cloud to determine the fourth location 502(4) of the dynamic object 208(4). The mapping component 120 may then perform interpolation to determine the third location 502(3) of the dynamic object 208(4) using the second location 502(2) and the fourth location 502(4).

The mapping component 120 may then perform similar processes to track one or more other dynamic objects. For example, the tracking component 122 may perform similar processes to track the dynamic object 208(5) as the dynamic object 208(5) moves throughout the environment 204. As shown, the tracking component 122 may determine that the dynamic object 208(5) was located at a first location 504(1) at a first time, a second location 504(2) at a second time, a third location 504(3) at a third time, and a fourth location 504(4) at a fourth time.

Referring back to the example of FIG. 1, the process 100 may include the mapping component 120 “re-inserting” one or more of the dynamic objects into the map that already represents the locations of the static objects. For instance, and for a dynamic object, the mapping component 120 may use information associated with the track of the dynamic object and/or information associated with the 3D surface of the dynamic object to re-insert the dynamic object back into the map. In some examples, by performing these processes, the mapping component 120 may generate a fourth dimension associated with the map. For instance, the map may represent the locations of the dynamic object at various instances in time. For example, a first instance of the map (which may also be referred to as a “first potion of the map”) associated with a first time may represent the dynamic object at a first location within the environment, a second instance of the map (e.g., a “second portion of the map”) associated with a second time may represent the dynamic object at a second location within the environment, a third instance of the map (e.g., a “third portion of the map”) associated with a third time may represent the dynamic object at a third location within the environment, and/or so forth. The mapping component 120 may then perform similar processes to re-insert one or more other dynamic objects into the map.

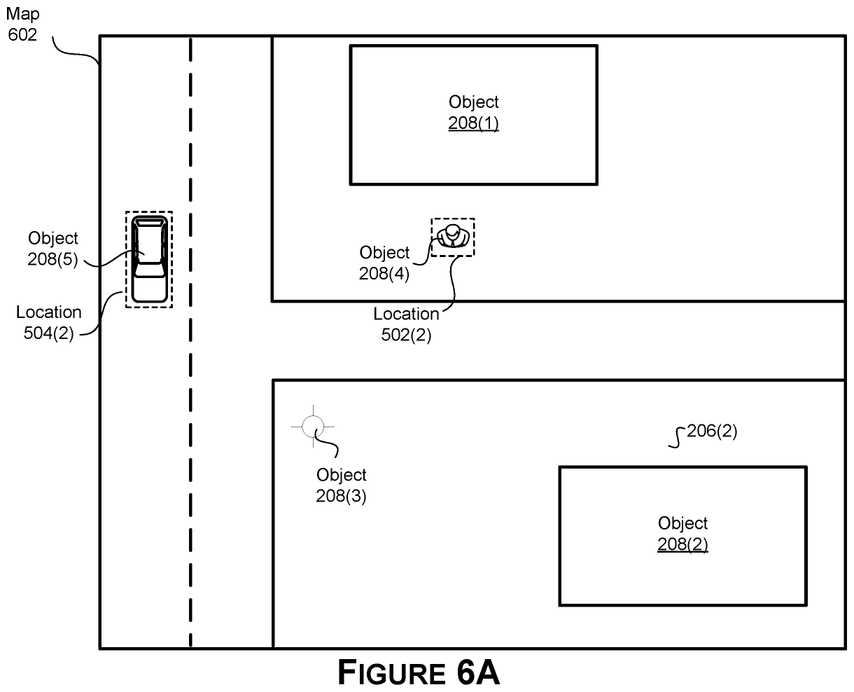

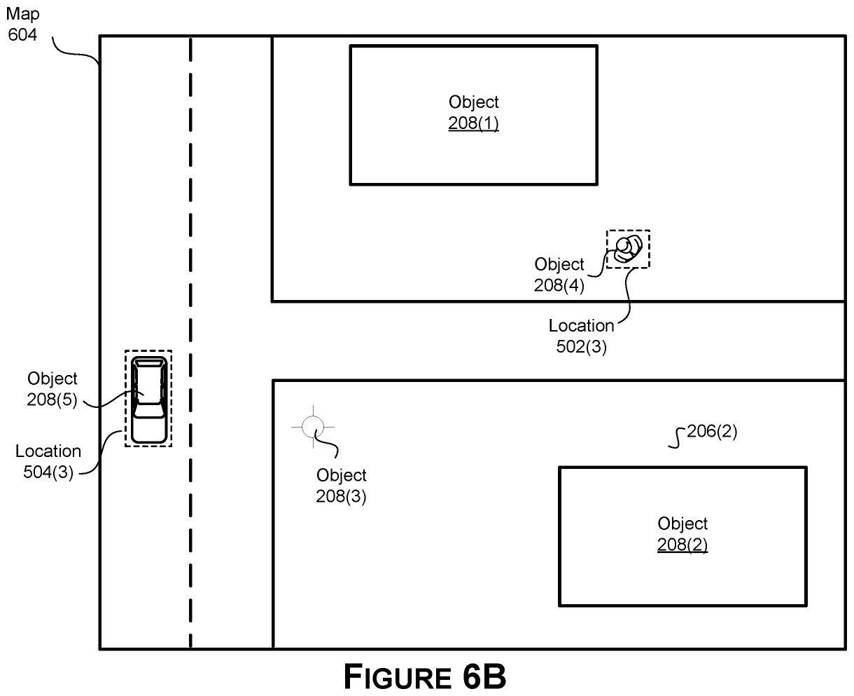

For instance, FIGS. 6A-6B illustrate examples of re-inserting the dynamic objects 208(4)-(5) into the map 402, in accordance with some embodiments of the present disclosure. As shown by the example of FIG. 6A, a first instance of the map 402 that is associated with the second time, which is represented by a map 602, may include the dynamic object 208(4) located at the second location 502(2) and the dynamic object 208(5) located at the second location 504(2). Next, and as shown by the example of FIG. 6B, a second instance of the map 402 that is associated with the third time, which is represented by a map 604, may include the dynamic object 208(4) located at the third location 502(3) and the dynamic object 208(5) located at the third location 504(3).

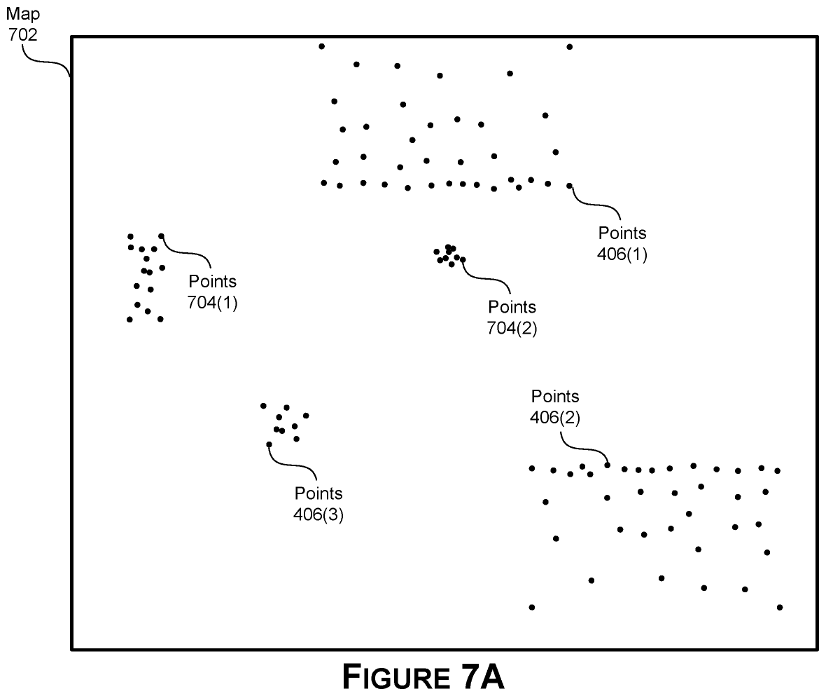

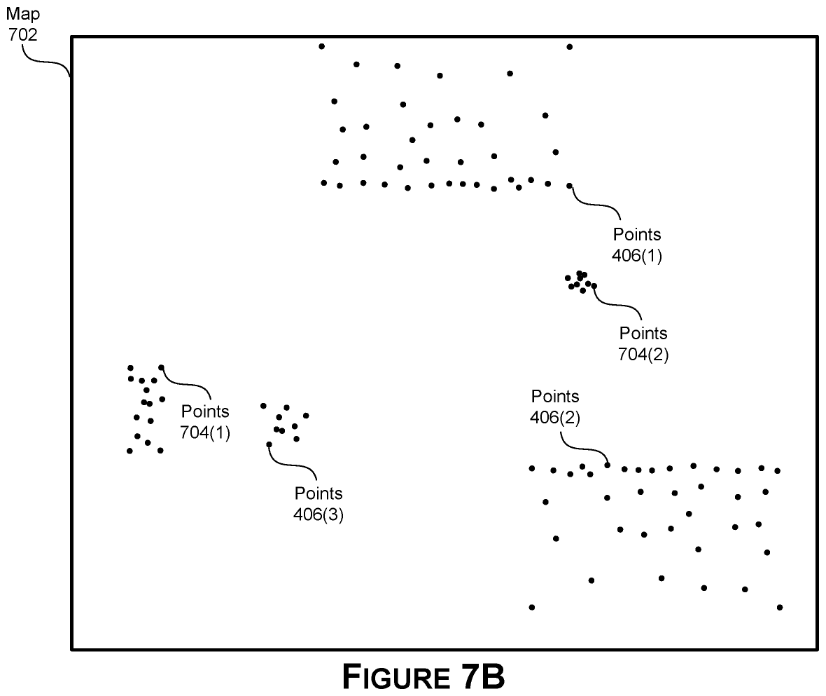

FIGS. 7A-7B illustrate examples of re-inserting the dynamic objects 208(4)-(5) into the map 404, in accordance with some embodiments of the present disclosure. As shown by the example of FIG. 7A, a first instance of the map 404 that is associated with the second time, which is represented by a map 702, may include points 704(1) associated with the dynamic object 208(4) located at the second location 502(2) and points 704(2) associated with the dynamic object 208(5) located at the second location 504(2). Next, and as shown by the example of FIG. 7B, a second instance of the map 404 that is associated with the third time, which is represented by a map 706, may include the points 704(1) associated with the dynamic object 208(4) located at the third location 502(3) and the points 704(2) associated with the dynamic object 208(5) located at the third location 504(3).

Referring back to the example of FIG. 1, the process 100 may include an annotation component 124 using the map to perform one or more operations, such as to propagate the annotations for the objects represented by the first sensor data 102 to one or more of the objects represented by the second sensor data 106. For instance, and for a sensor representation (e.g., an image) represented by the second sensor data 106, the process 100 may include the annotation component 124 using a projection component 126 to determine a time associated with the sensor representation. In some examples, such as when the second sensor(s) 108 includes an image sensor(s) with a rolling shutter(s), the time may include a time period between a first time that the image sensor(s) started generating the image (e.g., an initial pixel was generated) and a second time that the image sensor(s) finished generating the image (e.g., a last pixel was generated). The projection component 126 may then determine a portion of the first sensor data 102 that is associated with the time. For instance, and again if the first sensor data 102 includes LiDAR data, the projection component 126 may determine the portion of the LiDAR data that is associated with the nearest LiDAR sensor(s) spin associated with the time and/or a number of LiDAR sensor(s) spins that are spatially close (with respect to the positions of the LiDAR sensor at the time instances in which the LiDAR sensor(s) spin), and in which the objects and corresponding point data are spatially close from the point data in previous and/or subsequent spins. The number of LiDAR sensor(s) spins that are spatially close may include a first number of spins before the nearest spin and/or a second number of spins after the nearest spin. As described herein, a number of spins may include, but is not limited to, one spin, five spins, ten spins, and/or any other number of spins.

The projection component 126 may then cause the map component 110 to generate a map using the portion of the first sensor data 102 (e.g., using one or more of the processes described herein), if the map is not already generated, or determine a portion of the map that is associated with the portion of the first sensor data 102, such as if the map is already generated. As described herein, in some examples, the portion of the map may be associated with an instance in time, such that the portion of the map indicates the locations of the dynamic objects within the environment at the instance in time. In other words, the portion of the map may indicate where the dynamic objects were located at the time and/or around the time that the sensor representation represented by the second sensor data 106 was generated.

The projection component 126 may then use the map to project one or more of the objects from the environment to the sensor representation. For instance, and for an object (e.g., a static object or a dynamic object), the projection component 126 may project the points associated with the object, as represented by the map, to the sensor representation. In some examples, such as when the sensor representation is an image, the points are projected to pixels associated with the image. In some examples, the projection component 126 may perform one or more additional processes when projecting the points.

For example, such as when the second sensor(s) 108 includes the rolling shutter and the sensor representation is an image, the projection component 126 may use the pixel locations of the initial projection to estimate timestamps associated with the pixel locations (e.g., since the pixels are generated at various times when the second sensor(s) 108 uses the rolling shutter). The projection component 126 may then interpolate the trajectory of the vehicle and the trajectory of the dynamic object to determine a new pose and/or location associated with the dynamic object at the various times. Additionally, the projection component 126 may refine the projected coordinates of the dynamic object using the new pose and/or location associated with the dynamic object. The projection component 126 may then continue to perform these processes for one or more iterations in order to better project the points associated with the dynamic object on the image. Additionally, the projection component 126 may perform similar processes for one or more additional objects (e.g., one or more static objects and/or one or more dynamic objects).

For example, such as when the second sensor(s) 108 includes a rolling shutter, one or more (e.g., each) pixel row may be associated with a different timestamp and the projection component 126 may not have advance knowledge of which 3D points or parts of 3D labels (e.g., annotations) from the map will project on to which camera pixels. Because of this, the target timestamps may not be known on a per-label basis. For instance, different labels might have different target timestamps, as they project on to different pixels on second sensor(s) 108, even if on the same image frame. As such, one technique that the projection component 126 may use to perform such projection is to (1) iterate over one or more (e.g., all) pixel rows of the second sensor(s) 108, (2) for one or more (e.g., each) pixel row, extract its timestamp, (3) sample a 4D map at one or more (e.g., each) timestamp, (4) perform a 3D projection of the sampled map on the image, and (5) pick the projected points that fall onto the pixel row picked in (1). The projection component 126 may then repeat the above steps for one or more (e.g., all) rows.

In some examples, this technique may result in a pixel-accurate label transfer from the map to the image, but may also require N×K point projections and N temporal map samples, where N is the vertical resolution of the image and K is the number of 3D points in the map. As such, in some examples, the projection component 126 may use an accelerated technique that works well in practical scenarios. For instance, the projection component 126 may sample the 4D map for the first and last camera pixel row, and for one or more (e.g., each) 3D point, a range of pixel rows (timestamps) is computed by linearly interpolating the 2D projection of the 3D point between first and last timestamps. This may minimize, for each 3D point, the number of projections (steps (3) and (4) in original technique) needed to estimate the true pixel position by eliminating pixel rows where the 3D point may not be projected.

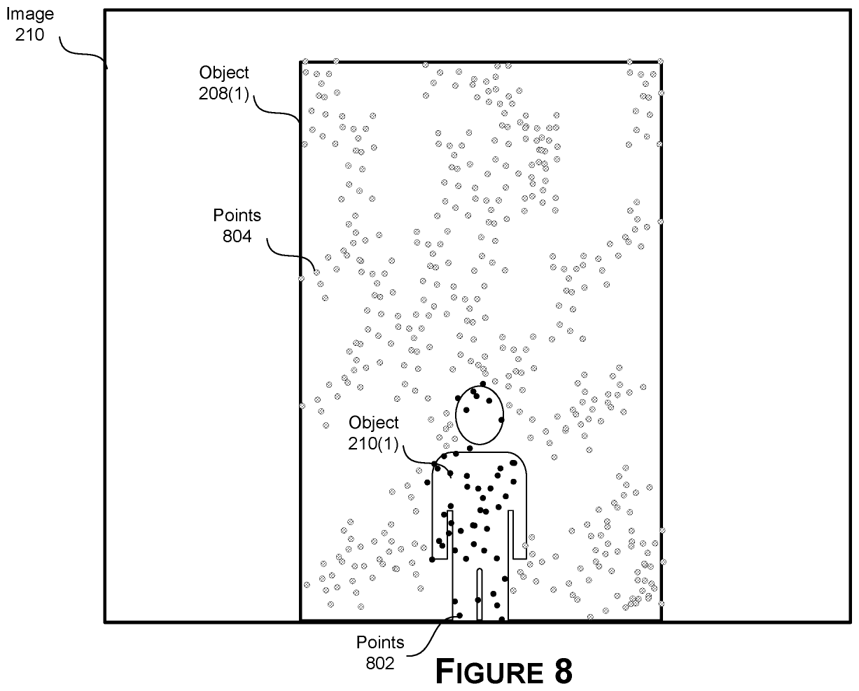

For instance, FIG. 8 illustrates an example of projecting points associated with a map to the image 210, in accordance with some embodiments of the present disclosure. As shown, the projection component 126 may perform one or more of the processes described herein to project the points 704(2) associated with the dynamic object 208(4) onto the image 210, where the projected points are represented by dark points 802 (although only one is labeled for clarity reasons). The projection component 126 may further perform one or more of the processes described herein to project the points 406(1) associated with the static object 208(1) onto the image 210, where the projected points are represented by the grey points 804 (although only one is labeled for clarity reasons). In some examples, the points 802 and/or the points 804 may be associated with pixels of the image 210.

Referring back to the example of FIG. 1, the process 100 may include the annotation component 124 using a labeling component 128 to annotate the sensor representation. In some examples, the labeling component 128 uses the annotations associated with the first sensor data 102 and/or the map to determine the annotations associated with the sensor representation. For example, and for an object, the labeling component 128 may use the annotation associated with the object as represented by the first sensor data 102 and/or the annotation associated with the points of the object as represented by the map to annotate the object as depicted by the sensor representation of the second sensor data 106. In some examples, the labeling component 128 may perform one or more additional processes when annotating the sensor representation. For example, and for an object, the labeling component 128 may generate a bounding shape, such as a bounding box, that indicates the location of the object within the senor representation. The labeling component 128 may then further annotate the sensor representation to include the bounding shape.

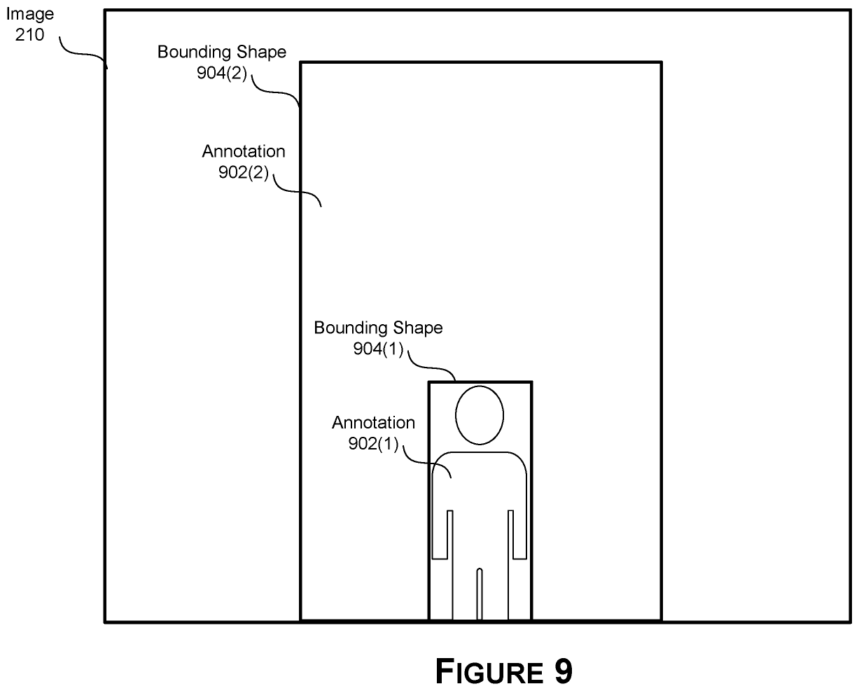

For instance, FIG. 9 illustrates an example of annotating the image 210, in accordance with some embodiments of the present disclosure. As shown, the labeling component 128 may use the annotation 302(4) associated with the dynamic object 208(4) to annotate the dynamic object 208(4) as depicted by the image 210 with an annotation 902(1). In some examples, the labeling component 128 may further generate a bounding shape 904(1) associated with the dynamic object 208(4). In such examples, the labeling component 128 may perform one or more processes to generate the bounding shape 904(1), such as by using the points 704(2) associated with the dynamic object 208(4) and/or the points 802 associated with the dynamic object 208(4). The labeling component 128 may then perform similar processes to determine an annotation 902(2) associated with the static object 804(1) and/or a bounding shape 904(2) associated with the static object 804(1).

Referring back to the example of FIG. 1, the process 100 may include the annotation component 124 using an occlusion component 130 to determine whether one or more objects are occluded by one or more other objects. For instance, based on the projection component 126 projecting the points onto the sensor representation, points (e.g., pixels) of the sensor representation may be associated with depth values. As such, the occlusion component 130 may use first depth values associated with a first object and second depth values associated with a second object to determine whether the first object is occluded by the second object or whether the second object is occluded by the first object. For a first example, if the first depth values are greater than the second depth values, then the occlusion component 130 may determine that the second object at least partially occludes the first object within the sensor representation (e.g., the second object is closer to the second sensor(s) 108 than the first object). For a second example, if the second depth values are greater than the first depth values, then the occlusion component 130 may determine that the first object at least partially occludes the second object within the sensor representation (e.g., the first object is closer to the second sensor(s) 108 than the second object).

For instance, and referring back to the example of FIG. 8, the occlusion component 130 may use the points 802 associated with the dynamic object 208(4) and the points 804 associated with the static object 208(1) to determine that the dynamic object 208(4) at least partially occludes the static object 208(1) within the image 210. For example, the occlusion component 130 may determine that depth values associated with the points 804 are greater than depth values associated with the points 802. Since the depth values associated with the points 804 are greater than the depth values associated with the points 802, the dynamic object 804(4) may be located closer than the static object 804(1) to the second sensor(s) that generated the image 210. As such, the occlusion component 130 may determine that the dynamic object 208(4) at least partially occludes the static object 208(1). In some examples, the occlusion component 130 may then identify a portion of the image 210 that is associated with the occlusion. For instance, the occlusion component 130 may determine that the portion of the image 210 that depicts the dynamic object 208(4) includes the occluded portion of the image associated with the static object 208(1).

Referring back to the example of FIG. 1, the process 100 may include the annotation component 124 outputting annotation data 132 associated with the second sensor data 106. For example, the annotation data 132 may represent at least one or more annotations for one or more objects represented by the second sensor data 106. Additionally, in some examples, the annotation data 132 may include additional information associated with the object(s). For example, the annotation data 132 may represent occlusion information, such as which objects are occluded by other objects and/or the locations of the occlusions within the sensor representations.

The process 100 may include the annotation component 124 using a depth component 134 that is configured to generate depth maps associated with the objects, where the depth maps are represented by depth map data 136. In some examples, a depth map may correspond to a sensor representation associated with the second sensor data 106. For example, if the sensor representation is an image that depicts one or more objects, then the depth map may indicate one or more distances to the one or more objects. In such an example, the depth map may include a similar FOV as the image, such that the depth map and the image represent a similar portion of the environment.

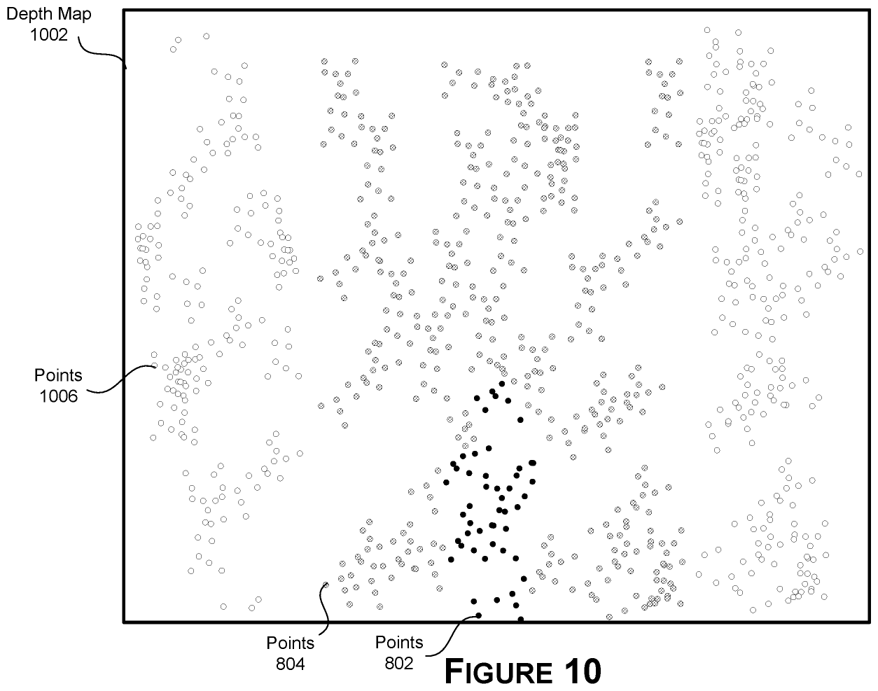

For instance, FIG. 10 illustrates an example of a depth map 1002, in accordance with some embodiments of the present disclosure. In the example of FIG. 10, the depth map 1002 may be associated with the image 210. For instance, the depth map 1002 may include the points 802 associated with the dynamic object 804(4), the points 804 associated with the static object 804(1), and points 1004 associated with a background of the environment 204. As described herein, the points 802 may indicate depth values associated with the dynamic object 804(4), the points 804 may indicate depth values associated with the static objects 804(1), and the points 1004 may indicate depth values associated with the background.

Referring back to the example of FIG. 1, in some examples, the depth component 134 may perform one or more processes in order to improve depth maps. For instance, and as described herein, in some examples, the first sensor(s) 104 may include a first sampling resolution and the second sensor(s) 108 may include a second sampling resolution, where the second sampling resolution is greater than the first sampling resolution. As such, and for an object depicted by the sensor representation, such as an object that is located proximate (e.g., within a threshold distance) to the vehicle, a portion of the points (e.g., pixels) associated with the object may not include depth information (e.g., depth values). In other words, if the sensor representation is an image, and a number of pixels of the image depict the object, only a portion of the number of pixels may be associated with depth information (e.g., depth values) since the second sampling resolution is greater than the first sampling resolution.

The depth component 134 may process the sensor representation and, based on the processing, determine the points of the sensor representation that are associated with the object. In some examples, the processing used to determine the points of the sensor representation that are associated with the object may include surface reconstruction. The depth component 134 may then use a first portion of the points that are already associated with depth information to generate depth information associated with a second portion of the points that are not already associated with depth information. For instance, the depth component 134 may determine that the depth information associated with the second portion of the points is similar to the depth information associated with the first portion of the points. In other words, the depth component 134 may determine that points that are associated with the same object and/or points that are located proximate to one another should include substantially similar depth values.

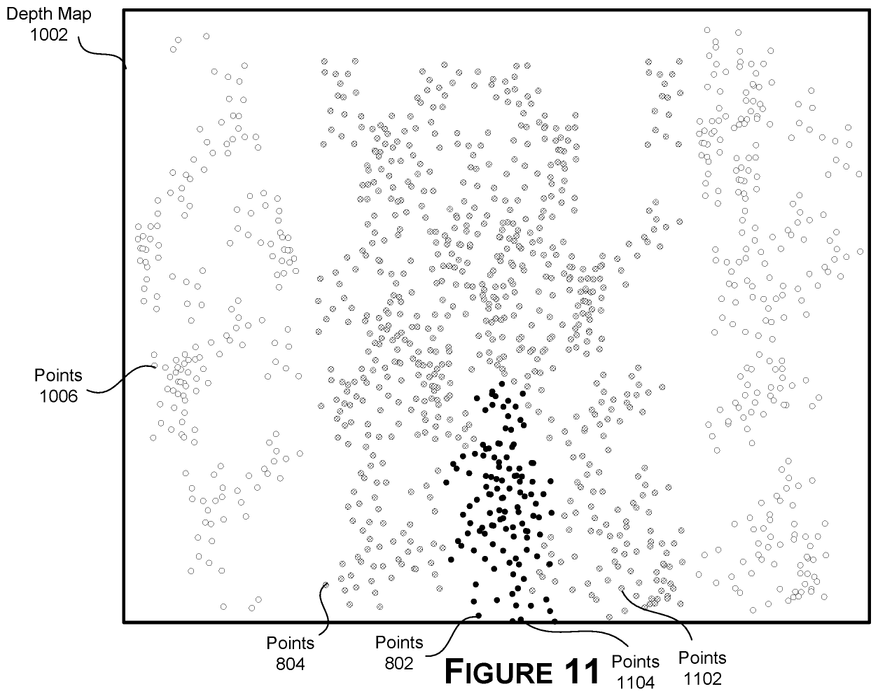

For instance, FIG. 11 illustrates an example of updating the depth map 1002, in accordance with some examples of the present disclosure. In the example of FIG. 11, the depth component 134 may have performed surface reconstruction using the image 210. In some examples, based on performing the surface reconstruction, the depth component 134 may determine first points (e.g., first pixels) of the image 210 that are associated with the static object 208(1) and/or second points (e.g., second pixels) of the image 210 that are associated with the dynamic object 208(4). As described herein, based on the different sampling resolutions of the sensors, at least a portion of the first points and/or at least a portion of the second points may not be associated with depth information (e.g., depth values). As such, and for the static object 208(1), the depth component 134 may use the portion of the first points that are associated with depth information to determine depth information for the portion of the first points that is not already associated with depth information. Additionally, and for the dynamic object 208(4), the depth component 134 may use the portion of the second points that are associated with depth information to determine depth information for the portion of the second points that is not already associated with depth information.

As such, and as illustrated by the example of FIG. 11, the depth component 134 may update the depth map 1002 to include additional points 1102 (although only one is labeled for clarity reasons) associated with the static object 208(1) and additional points 1104 (although only one is labeled for clarity reasons) associated with the dynamic object 208(4). In some examples, this may provide improvements, such as a better understanding of the environment 204 surrounding the vehicle 202. Additionally, in some examples, the occlusion component 130 may use this updated depth map 1002 to better determine which objects are occluded by other objects.

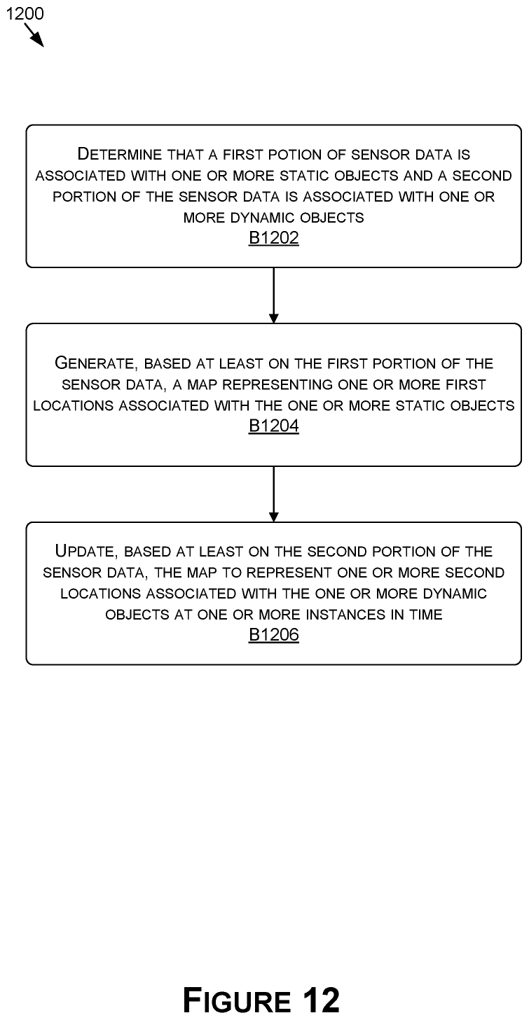

Now referring to FIGS. 12-14, each block of methods 1200, 1300, and 1400, described herein, comprises a computing process that may be performed using any combination of hardware, firmware, and/or software. For instance, various functions may be carried out by a processor executing instructions stored in memory. The methods 1200, 1300, and 1400 may also be embodied as computer-usable instructions stored on computer storage media. The methods 1200, 1300, and 1400 may be provided by a standalone application, a service or hosted service (standalone or in combination with another hosted service), or a plug-in to another product, to name a few. In addition, the methods 1200, 1300, and 1400 are described, by way of example, with respect to FIG. 1. However, these methods 1200, 1300, and 1400 may additionally or alternatively be executed by any one system, or any combination of systems, including, but not limited to, those described herein.

FIG. 12 is a flow diagram showing a method 1200 for generating a map and/or map data using sensor data, in accordance with some embodiments of the present disclosure. The method 1200, at block B1202, may include determining that a first portion of sensor data is associated with one or more static objects and a second portion of the sensor data is associated with one or more dynamic objects. For instance, the map component 110 (e.g., the sensor component 118) may determine that the first portion of the first sensor data 102 is associated with the static object(s) and the second portion of the first sensor data 102 is associated with the dynamic object(s). In some examples, the map component 110 uses one or more annotations associated with the objects to determine portions of the first sensor data 102. In some examples, such as when the first sensor data 102 represents a point cloud, the first portion of the point cloud may include one or more first points associated with the static object(s) and the second portion of the point cloud may include one or more second points associated with the dynamic object(s).

The method 1200, at block B1204, may include generating, based at least on the first portion of the sensor data, a map and/or map data representing one or more first locations associated with the one or more static objects. For instance, the map component 110 (e.g., the sensor component 118) may generate updated sensor data 102 by removing the second portion of the first sensor data 102. The map component 110 (e.g., the mapping component 120) may then use the updated sensor data 102 to generate the map (data) representing the first location(s) of the static object(s). In some examples, the map (data) may thus include a 3D representation associated with the static object(s) located within the environment.

The method 1200, at block B1206, may include updating, based at least on the second portion of the sensor data, the map (data) to represent one or more second locations associated with the one or more dynamic objects at one or more instances in time. For instance, the map component 110 (e.g., the tracking component 122) may process the first sensor data 102 (e.g., the second portion of the first sensor data 102) in order to track the location(s) of the dynamic object(s) at the one or more instances in time. The map component 110 (e.g., the mapping component 120) may then use the track(s) to update the map (data) to represent the second location(s) of the dynamic object(s) at the one or more instances in time. As such, the map (data) may then include a four-dimensional representation associated with the environment, where the fourth dimension is associated with the location(s) of the dynamic object(s) within the environment at different instances in time.

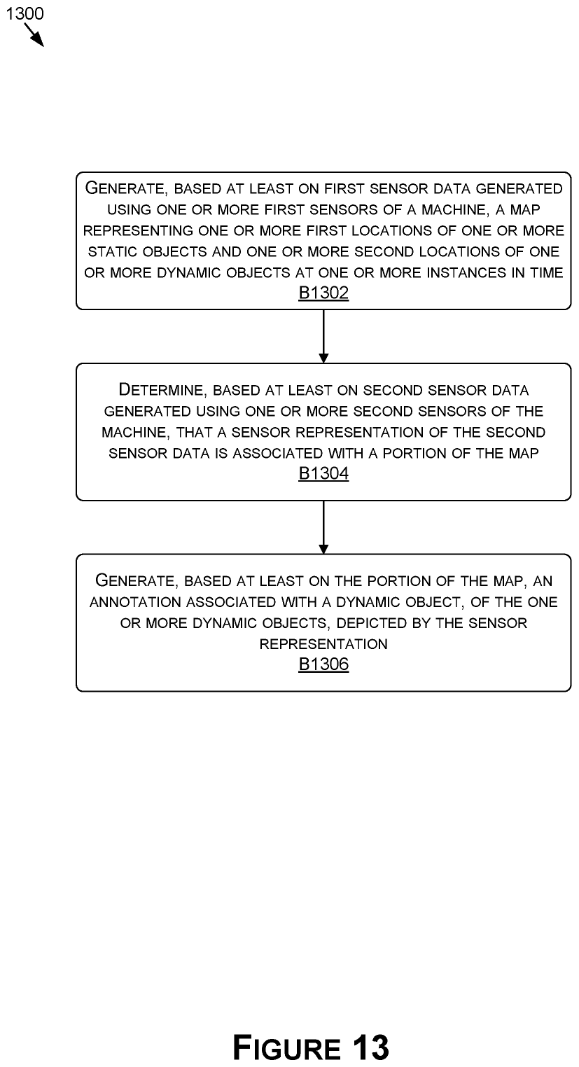

FIG. 13 is a flow diagram showing a method 1300 for propagating an annotation between sensor representations, in accordance with some embodiments of the present disclosure. The method 1300, at block B1302, may include generating, based at least on first sensor data generated using one or more first sensors of a machine, a map (and/or map data) representing one or more first locations of one or more static objects and one or more second locations of one or more dynamic objects at one or more instances in time. For instance, the map component 110 may use the first sensor data 102 to generate the map (data) representing the first location(s) of the static object(s) and the second location(s) of the dynamic object(s). As described herein, the second location(s) of the dynamic object(s) may be associated with one or more instances in time.

The method 1300, at block B1304, may include determining, based at least on second sensor data generated using one or more second sensors of the machine, that a sensor representation of the second sensor data is associated with a portion of the map (data). For instance, the annotation component 124 (e.g., the projection component 126) may determine that the sensor representation of the second sensor data 106 (e.g., an image represented by the second sensor data 106) is associated with a portion of the map (data). In some examples, the annotation component 124 makes the determination based on a time associated with the sensor representation, one or more characteristics (e.g., a location, an orientation, a FOV, etc.) associated with the first sensor(s) 104, one or more characteristics (e.g., a location, an orientation, a FOV, etc.) associated with the second sensor(s) 108, one or more parameters that align the first sensor(s) 104 with the second sensor(s) 108, and/or the like. In some examples, based on the portion of the map (data), the annotation component 124 may then project points associated with one or more of the static object(s) and/the or one or more dynamic object(s) onto the sensor representation.

The method 1300, at block B1306, may include generating, based at least on the portion of the map (data), an annotation associated with a dynamic object, of the one or more dynamic objects, depicted by the sensor representation. For instance, the annotation component 124 (e.g., the labeling component 128) may determine, using the first sensor data 102 and/or the map, that the dynamic object is associated with the annotation. As such, the annotation component 124 may generate the annotation associated with the dynamic object depicted by the sensor representation. In some examples, annotation component 124 may perform one or more additional and/or alternative processes, such as generating a bounding shape associated with the dynamic object.

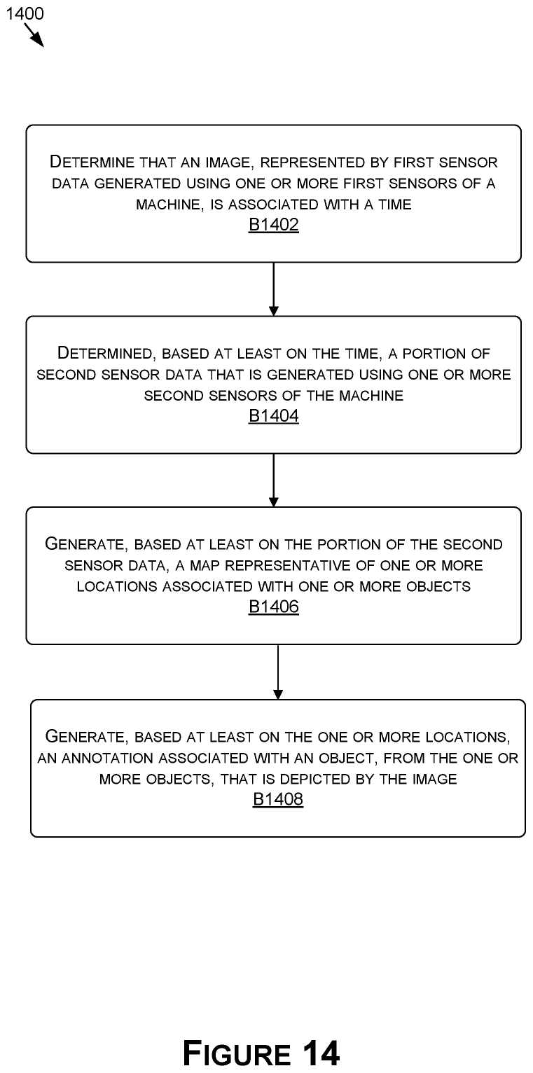

FIG. 14 is a flow diagram showing a method 1400 for generating a map (and/or map data) using first sensor data and then using the map (data) to annotate second sensor data, in accordance with some embodiments of the present disclosure. The method 1400, at block B1402, may include determining that an image, represented by first image data generated using one or more first sensors of a machine, is associated with a time. For instance, the annotation component 124 (e.g., the projection component 126) may determine that the image represented by the second sensor data 106 is associated with the time. In some examples, such as when the second sensor(s) 108 includes a rolling shutter, the annotation component 124 may determine that the image is associated with a time period between a first time when the second sensor(s) 108 began generating the image and a second time when the second sensor(s) 108 finished generating the image.

The method 1400, at block B1404, may include determining, based at least on the time, a portion of second sensor data that is generated using one or more second sensors of the machine. For instance, the annotation component 124 (e.g., the projection component 126) may determine the portion of the first sensor data 102 using the time. In some examples, such as when the first sensor(s) 104 include a LiDAR sensor(s), the portion of the first sensor data 102 may be generated during a spin of the LiDAR sensor(s) that occurred approximate to the time and/or one or more additional spins that are spatially close to the spin. In other words, the first sensor(s) 104 may generate the portion of the first sensor data 102 at approximate the same time that the second sensor(s) 108 generated the image.

The method 1400, at block B1406, may include generating, based at least on the portion of the second sensor data, a map (and/or map data) representative of one or more locations associated with one or more objects. For instance, the annotation component 124 may cause the map component 110 to generate the map (data) using the portion of the first sensor data 102. As described herein, the map (data) may represent at least the location(s) of the object(s) (e.g., a static object(s) and/or a dynamic object(s)) proximate to the time, an annotation(s) associated with the object(s), and/or depth information associated with the object(s).

The method 1400, at block B1408, may include generating, based at least on the one or more locations, an annotation associated with an object, from the one or more objects, that is depicted by the image. For instance, the annotation component 124 (e.g., the projection component 126) may use the map (data) to project the object onto the image. In some examples, projecting the object onto the image includes projecting points associated with the object onto pixels associated with the image. The annotation component 124 (e.g., the labeling component 128) may then use an annotation associated with the object, such as from the first sensor data 102 and/or the map (data), to generate the annotation associated with the object as depicted by the image. In some examples, the annotation component 124 may perform additional processes, such as generating a bounding shape associated with the object, determining whether the object is occluded, and/or the like.

### Example Autonomous Vehicle

FIG. 15A is an illustration of an example autonomous vehicle 1500, in accordance with some embodiments of the present disclosure. The autonomous vehicle 1500 (alternatively referred to herein as the “vehicle 1500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1500 may be capable of functionality in accordance with one or more of Level 3-Level 5 of the autonomous driving levels. The vehicle 1500 may be capable of functionality in accordance with one or more of Level 1-Level 5 of the autonomous driving levels. For example, the vehicle 1500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1500 or other machine, such as being fully autonomous, being highly autonomous, being conditionally autonomous, being partially autonomous, providing assistive autonomy, being semi-autonomous, being primarily autonomous, or other designation.

The vehicle 1500 may include components such as a chassis, a vehicle body, wheels (e.g., 2, 4, 6, 8, 18, etc.), tires, axles, and other components of a vehicle. The vehicle 1500 may include a propulsion system 1550, such as an internal combustion engine, hybrid electric power plant, an all-electric engine, and/or another propulsion system type. The propulsion system 1550 may be connected to a drive train of the vehicle 1500, which may include a transmission, to enable the propulsion of the vehicle 1500. The propulsion system 1550 may be controlled in response to receiving signals from the throttle/accelerator 1552.

A steering system 1554, which may include a steering wheel, may be used to steer the vehicle 1500 (e.g., along a desired path or route) when the propulsion system 1550 is operating (e.g., when the vehicle is in motion). The steering system 1554 may receive signals from a steering actuator 1556. The steering wheel may be optional for full automation (Level 5) functionality.

The brake sensor system 1546 may be used to operate the vehicle brakes in response to receiving signals from the brake actuators 1548 and/or brake sensors.

Controller(s) 1536, which may include one or more system on chips (SoCs) 1504 (FIG. 15C) and/or GPU(s), may provide signals (e.g., representative of commands) to one or more components and/or systems of the vehicle 1500. For example, the controller(s) may send signals to operate the vehicle brakes via one or more brake actuators 1548, to operate the steering system 1554 via one or more steering actuators 1556, to operate the propulsion system 1550 via one or more throttle/accelerators 1552. The controller(s) 1536 may include one or more onboard (e.g., integrated) computing devices (e.g., supercomputers) that process sensor signals, and output operation commands (e.g., signals representing commands) to enable autonomous driving and/or to assist a human driver in driving the vehicle 1500. The controller(s) 1536 may include a first controller 1536 for autonomous driving functions, a second controller 1536 for functional safety functions, a third controller 1536 for artificial intelligence functionality (e.g., computer vision), a fourth controller 1536 for infotainment functionality, a fifth controller 1536 for redundancy in emergency conditions, and/or other controllers. In some examples, a single controller 1536 may handle two or more of the above functionalities, two or more controllers 1536 may handle a single functionality, and/or any combination thereof.

The controller(s) 1536 may provide the signals for controlling one or more components and/or systems of the vehicle 1500 in response to sensor data received from one or more sensors (e.g., sensor inputs). The sensor data may be received from, for example and without limitation, global navigation satellite systems (“GNSS”) sensor(s) 1558 (e.g., Global Positioning System sensor(s)), RADAR sensor(s) 1560, ultrasonic sensor(s) 1562, LIDAR sensor(s) 1564, inertial measurement unit (IMU) sensor(s) 1566 (e.g., accelerometer(s), gyroscope(s), magnetic compass(es), magnetometer(s), etc.), microphone(s) 1596, stereo camera(s) 1568, wide-view camera(s) 1570 (e.g., fisheye cameras), infrared camera(s) 1572, surround camera(s) 1574 (e.g., 360 degree cameras), long-range and/or mid-range camera(s) 1598, speed sensor(s) 1544 (e.g., for measuring the speed of the vehicle 1500), vibration sensor(s) 1542, steering sensor(s) 1540, brake sensor(s) (e.g., as part of the brake sensor system 1546), and/or other sensor types.

One or more of the controller(s) 1536 may receive inputs (e.g., represented by input data) from an instrument cluster 1532 of the vehicle 1500 and provide outputs (e.g., represented by output data, display data, etc.) via a human-machine interface (HMI) display 1534, an audible annunciator, a loudspeaker, and/or via other components of the vehicle 1500. The outputs may include information such as vehicle velocity, speed, time, map data (e.g., the High Definition (“HD”) map 1522 of FIG. 15C), location data (e.g., the vehicle's 1500 location, such as on a map), direction, location of other vehicles (e.g., an occupancy grid), information about objects and status of objects as perceived by the controller(s) 1536, etc. For example, the HMI display 1534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1500 further includes a network interface 1524 which may use one or more wireless antenna(s) 1526 and/or modem(s) to communicate over one or more networks. For example, the network interface 1524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 15B is an example of camera locations and fields of view for the example autonomous vehicle 1500 of FIG. 15A, in accordance with some embodiments of the present disclosure. The cameras and respective fields of view are one example embodiment and are not intended to be limiting. For example, additional and/or alternative cameras may be included and/or the cameras may be located at different locations on the vehicle 1500.

The camera types for the cameras may include, but are not limited to, digital cameras that may be adapted for use with the components and/or systems of the vehicle 1500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1500 (e.g., front-facing cameras) may be used for surround view, to help identify forward facing paths and obstacles, as well aid in, with the help of one or more controllers 1536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1570 that may be used to perceive objects coming into view from the periphery (e.g., pedestrians, crossing traffic or bicycles). Although only one wide-view camera is illustrated in FIG. 15B, there may be any number (including zero) of wide-view cameras 1570 on the vehicle 1500. In addition, any number of long-range camera(s) 1598 (e.g., a long-view stereo camera pair) may be used for depth-based object detection, especially for objects for which a neural network has not yet been trained. The long-range camera(s) 1598 may also be used for object detection and classification, as well as basic object tracking.

Any number of stereo cameras 1568 may also be included in a front-facing configuration. In at least one embodiment, one or more of stereo camera(s) 1568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1568 may be used in addition to, or alternatively from, those described herein.

Cameras with a field of view that include portions of the environment to the side of the vehicle 1500 (e.g., side-view cameras) may be used for surround view, providing information used to create and update the occupancy grid, as well as to generate side impact collision warnings. For example, surround camera(s) 1574 (e.g., four surround cameras 1574 as illustrated in FIG. 15B) may be positioned to on the vehicle 1500. The surround camera(s) 1574 may include wide-view camera(s) 1570, fisheye camera(s), 360 degree camera(s), and/or the like. Four example, four fisheye cameras may be positioned on the vehicle's front, rear, and sides. In an alternative arrangement, the vehicle may use three surround camera(s) 1574 (e.g., left, right, and rear), and may leverage one or more other camera(s) (e.g., a forward-facing camera) as a fourth surround view camera.

Cameras with a field of view that include portions of the environment to the rear of the vehicle 1500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1598, stereo camera(s) 1568), infrared camera(s) 1572, etc.), as described herein.

FIG. 15C is a block diagram of an example system architecture for the example autonomous vehicle 1500 of FIG. 15A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1500 in FIG. 15C are illustrated as being connected via bus 1502. The bus 1502 may include a Controller Area Network (CAN) data interface (alternatively referred to herein as a “CAN bus”). A CAN may be a network inside the vehicle 1500 used to aid in control of various features and functionality of the vehicle 1500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1502 is described herein as being a CAN bus, this is not intended to be limiting. For example, in addition to, or alternatively from, the CAN bus, FlexRay and/or Ethernet may be used. Additionally, although a single line is used to represent the bus 1502, this is not intended to be limiting. For example, there may be any number of busses 1502, which may include one or more CAN busses, one or more FlexRay busses, one or more Ethernet busses, and/or one or more other types of busses using a different protocol. In some examples, two or more busses 1502 may be used to perform different functions, and/or may be used for redundancy. For example, a first bus 1502 may be used for collision avoidance functionality and a second bus 1502 may be used for actuation control. In any example, each bus 1502 may communicate with any of the components of the vehicle 1500, and two or more busses 1502 may communicate with the same components. In some examples, each SoC 1504, each controller 1536, and/or each computer within the vehicle may have access to the same input data (e.g., inputs from sensors of the vehicle 1500), and may be connected to a common bus, such the CAN bus.

The vehicle 1500 may include one or more controller(s) 1536, such as those described herein with respect to FIG. 15A. The controller(s) 1536 may be used for a variety of functions. The controller(s) 1536 may be coupled to any of the various other components and systems of the vehicle 1500, and may be used for control of the vehicle 1500, artificial intelligence of the vehicle 1500, infotainment for the vehicle 1500, and/or the like.

The vehicle 1500 may include a system(s) on a chip (SoC) 1504. The SoC 1504 may include CPU(s) 1506, GPU(s) 1508, processor(s) 1510, cache(s) 1512, accelerator(s) 1514, data store(s) 1516, and/or other components and features not illustrated. The SoC(s) 1504 may be used to control the vehicle 1500 in a variety of platforms and systems. For example, the SoC(s) 1504 may be combined in a system (e.g., the system of the vehicle 1500) with an HD map 1522 which may obtain map refreshes and/or updates via a network interface 1524 from one or more servers (e.g., server(s) 1578 of FIG. 15D).

The CPU(s) 1506 may include a CPU cluster or CPU complex (alternatively referred to herein as a “CCPLEX”). The CPU(s) 1506 may include multiple cores and/or L2 caches. For example, in some embodiments, the CPU(s) 1506 may include eight cores in a coherent multi-processor configuration. In some embodiments, the CPU(s) 1506 may include four dual-core clusters where each cluster has a dedicated L2 cache (e.g., a 2 MB L2 cache). The CPU(s) 1506 (e.g., the CCPLEX) may be configured to support simultaneous cluster operation enabling any combination of the clusters of the CPU(s) 1506 to be active at any given time.

The CPU(s) 1506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1508 may include an integrated GPU (alternatively referred to herein as an “iGPU”). The GPU(s) 1508 may be programmable and may be efficient for parallel workloads. The GPU(s) 1508, in some examples, may use an enhanced tensor instruction set. The GPU(s) 1508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1508 may include at least eight streaming microprocessors. The GPU(s) 1508 may use compute application programming interface(s) (API(s)). In addition, the GPU(s) 1508 may use one or more parallel computing platforms and/or programming models (e.g., NVIDIA's CUDA).

The GPU(s) 1508 may be power-optimized for best performance in automotive and embedded use cases. For example, the GPU(s) 1508 may be fabricated on a Fin field-effect transistor (FinFET). However, this is not intended to be limiting and the GPU(s) 1508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1508 to access the CPU(s) 1506 page tables directly. In such examples, when the GPU(s) 1508 memory management unit (MMU) experiences a miss, an address translation request may be transmitted to the CPU(s) 1506. In response, the CPU(s) 1506 may look in its page tables for the virtual-to-physical mapping for the address and transmits the translation back to the GPU(s) 1508. As such, unified memory technology may allow a single unified virtual address space for memory of both the CPU(s) 1506 and the GPU(s) 1508, thereby simplifying the GPU(s) 1508 programming and porting of applications to the GPU(s) 1508.

In addition, the GPU(s) 1508 may include an access counter that may keep track of the frequency of access of the GPU(s) 1508 to memory of other processors. The access counter may help ensure that memory pages are moved to the physical memory of the processor that is accessing the pages most frequently.

The SoC(s) 1504 may include any number of cache(s) 1512, including those described herein. For example, the cache(s) 1512 may include an L3 cache that is available to both the CPU(s) 1506 and the GPU(s) 1508 (e.g., that is connected both the CPU(s) 1506 and the GPU(s) 1508). The cache(s) 1512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1504 may include an arithmetic logic unit(s) (ALU(s)) which may be leveraged in performing processing with respect to any of the variety of tasks or operations of the vehicle 1500—such as processing DNNs. In addition, the SoC(s) 1504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1506 and/or GPU(s) 1508.

The SoC(s) 1504 may include one or more accelerators 1514 (e.g., hardware accelerators, software accelerators, or a combination thereof). For example, the SoC(s) 1504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1508 and to off-load some of the tasks of the GPU(s) 1508 (e.g., to free up more cycles of the GPU(s) 1508 for performing other tasks). As an example, the accelerator(s) 1514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1508, and by using an inference accelerator, for example, a designer may target either the DLA(s) or the GPU(s) 1508 for any function. For example, the designer may focus processing of CNNs and floating point operations on the DLA(s) and leave other functions to the GPU(s) 1508 and/or other accelerator(s) 1514.

The accelerator(s) 1514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1514 (e.g., the hardware acceleration cluster) may include a computer vision network on-chip and SRAM, for providing a high-bandwidth, low latency SRAM for the accelerator(s) 1514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1566 output that correlates with the vehicle 1500 orientation, distance, 3D location estimates of the object obtained from the neural network and/or other sensors (e.g., LIDAR sensor(s) 1564 or RADAR sensor(s) 1560), among others.

The SoC(s) 1504 may include data store(s) 1516 (e.g., memory). The data store(s) 1516 may be on-chip memory of the SoC(s) 1504, which may store neural networks to be executed on the GPU and/or the DLA. In some examples, the data store(s) 1516 may be large enough in capacity to store multiple instances of neural networks for redundancy and safety. The data store(s) 1512 may comprise L2 or L3 cache(s) 1512. Reference to the data store(s) 1516 may include reference to the memory associated with the PVA, DLA, and/or other accelerator(s) 1514, as described herein.

The SoC(s) 1504 may include one or more processor(s) 1510 (e.g., embedded processors). The processor(s) 1510 may include a boot and power management processor that may be a dedicated processor and subsystem to handle boot power and management functions and related security enforcement. The boot and power management processor may be a part of the SoC(s) 1504 boot sequence and may provide runtime power management services. The boot power and management processor may provide clock and voltage programming, assistance in system low power state transitions, management of SoC(s) 1504 thermals and temperature sensors, and/or management of the SoC(s) 1504 power states. Each temperature sensor may be implemented as a ring-oscillator whose output frequency is proportional to temperature, and the SoC(s) 1504 may use the ring-oscillators to detect temperatures of the CPU(s) 1506, GPU(s) 1508, and/or accelerator(s) 1514. If temperatures are determined to exceed a threshold, the boot and power management processor may enter a temperature fault routine and put the SoC(s) 1504 into a lower power state and/or put the vehicle 1500 into a chauffeur to safe stop mode (e.g., bring the vehicle 1500 to a safe stop).

The processor(s) 1510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1510 may further include a real-time camera engine that may include a dedicated processor subsystem for handling real-time camera management.

The processor(s) 1510 may further include a high-dynamic range signal processor that may include an image signal processor that is a hardware engine that is part of the camera processing pipeline.

The processor(s) 1510 may include a video image compositor that may be a processing block (e.g., implemented on a microprocessor) that implements video post-processing functions needed by a video playback application to produce the final image for the player window. The video image compositor may perform lens distortion correction on wide-view camera(s) 1570, surround camera(s) 1574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1508 is not required to continuously render new surfaces. Even when the GPU(s) 1508 is powered on and active doing 3D rendering, the video image compositor may be used to offload the GPU(s) 1508 to improve performance and responsiveness.

The SoC(s) 1504 may further include a mobile industry processor interface (MIPI) camera serial interface for receiving video and input from cameras, a high-speed interface, and/or a video input block that may be used for camera and related pixel input functions. The SoC(s) 1504 may further include an input/output controller(s) that may be controlled by software and may be used for receiving I/O signals that are uncommitted to a specific role.

The SoC(s) 1504 may further include a broad range of peripheral interfaces to enable communication with peripherals, audio codecs, power management, and/or other devices. The SoC(s) 1504 may be used to process data from cameras (e.g., connected over Gigabit Multimedia Serial Link and Ethernet), sensors (e.g., LIDAR sensor(s) 1564, RADAR sensor(s) 1560, etc. that may be connected over Ethernet), data from bus 1502 (e.g., speed of vehicle 1500, steering wheel position, etc.), data from GNSS sensor(s) 1558 (e.g., connected over Ethernet or CAN bus). The SoC(s) 1504 may further include dedicated high-performance mass storage controllers that may include their own DMA engines, and that may be used to free the CPU(s) 1506 from routine data management tasks.

The SoC(s) 1504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1504 may be faster, more reliable, and even more energy-efficient and space-efficient than conventional systems. For example, the accelerator(s) 1514, when combined with the CPU(s) 1506, the GPU(s) 1508, and the data store(s) 1516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1508.

In some examples, a CNN for facial recognition and vehicle owner identification may use data from camera sensors to identify the presence of an authorized driver and/or owner of the vehicle 1500. The always on sensor processing engine may be used to unlock the vehicle when the owner approaches the driver door and turn on the lights, and, in security mode, to disable the vehicle when the owner leaves the vehicle. In this way, the SoC(s) 1504 provide for security against theft and/or carjacking.

In another example, a CNN for emergency vehicle detection and identification may use data from microphones 1596 to detect and identify emergency vehicle sirens. In contrast to conventional systems, that use general classifiers to detect sirens and manually extract features, the SoC(s) 1504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1562, until the emergency vehicle(s) passes.

The vehicle may include a CPU(s) 1518 (e.g., discrete CPU(s), or dCPU(s)), that may be coupled to the SoC(s) 1504 via a high-speed interconnect (e.g., PCIe). The CPU(s) 1518 may include an X86 processor, for example. The CPU(s) 1518 may be used to perform any of a variety of functions, including arbitrating potentially inconsistent results between ADAS sensors and the SoC(s) 1504, and/or monitoring the status and health of the controller(s) 1536 and/or infotainment SoC 1530, for example.

The vehicle 1500 may include a GPU(s) 1520 (e.g., discrete GPU(s), or dGPU(s)), that may be coupled to the SoC(s) 1504 via a high-speed interconnect (e.g., NVIDIA's NVLINK). The GPU(s) 1520 may provide additional artificial intelligence functionality, such as by executing redundant and/or different neural networks, and may be used to train and/or update neural networks based on input (e.g., sensor data) from sensors of the vehicle 1500.

The vehicle 1500 may further include the network interface 1524 which may include one or more wireless antennas 1526 (e.g., one or more wireless antennas for different communication protocols, such as a cellular antenna, a Bluetooth antenna, etc.). The network interface 1524 may be used to enable wireless connectivity over the Internet with the cloud (e.g., with the server(s) 1578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1500 information about vehicles in proximity to the vehicle 1500 (e.g., vehicles in front of, on the side of, and/or behind the vehicle 1500). This functionality may be part of a cooperative adaptive cruise control functionality of the vehicle 1500.

The network interface 1524 may include a SoC that provides modulation and demodulation functionality and enables the controller(s) 1536 to communicate over wireless networks. The network interface 1524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1500 may further include data store(s) 1528 which may include off-chip (e.g., off the SoC(s) 1504) storage. The data store(s) 1528 may include one or more storage elements including RAM, SRAM, DRAM, VRAM, Flash, hard disks, and/or other components and/or devices that may store at least one bit of data.

The vehicle 1500 may further include GNSS sensor(s) 1558. The GNSS sensor(s) 1558 (e.g., GPS, assisted GPS sensors, differential GPS (DGPS) sensors, etc.), to assist in mapping, perception, occupancy grid generation, and/or path planning functions. Any number of GNSS sensor(s) 1558 may be used, including, for example and without limitation, a GPS using a USB connector with an Ethernet to Serial (RS-232) bridge.

The vehicle 1500 may further include RADAR sensor(s) 1560. The RADAR sensor(s) 1560 may be used by the vehicle 1500 for long-range vehicle detection, even in darkness and/or severe weather conditions. RADAR functional safety levels may be ASIL B. The RADAR sensor(s) 1560 may use the CAN and/or the bus 1502 (e.g., to transmit data generated by the RADAR sensor(s) 1560) for control and to access object tracking data, with access to Ethernet to access raw data in some examples. A wide variety of RADAR sensor types may be used. For example, and without limitation, the RADAR sensor(s) 1560 may be suitable for front, rear, and side RADAR use. In some example, Pulse Doppler RADAR sensor(s) are used.

The RADAR sensor(s) 1560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1500 surroundings at higher speeds with minimal interference from traffic in adjacent lanes. The other two antennae may expand the field of view, making it possible to quickly detect vehicles entering or leaving the vehicle's 1500 lane.

Mid-range RADAR systems may include, as an example, a range of up to 1560 m (front) or 80 m (rear), and a field of view of up to 42 degrees (front) or 1550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1500 may further include ultrasonic sensor(s) 1562. The ultrasonic sensor(s) 1562, which may be positioned at the front, back, and/or the sides of the vehicle 1500, may be used for park assist and/or to create and update an occupancy grid. A wide variety of ultrasonic sensor(s) 1562 may be used, and different ultrasonic sensor(s) 1562 may be used for different ranges of detection (e.g., 2.5 m, 4 m). The ultrasonic sensor(s) 1562 may operate at functional safety levels of ASIL B.

The vehicle 1500 may include LIDAR sensor(s) 1564. The LIDAR sensor(s) 1564 may be used for object and pedestrian detection, emergency braking, collision avoidance, and/or other functions. The LIDAR sensor(s) 1564 may be functional safety level ASIL B. In some examples, the vehicle 1500 may include multiple LIDAR sensors 1564 (e.g., two, four, six, etc.) that may use Ethernet (e.g., to provide data to a Gigabit Ethernet switch).

In some examples, the LIDAR sensor(s) 1564 may be capable of providing a list of objects and their distances for a 360-degree field of view. Commercially available LIDAR sensor(s) 1564 may have an advertised range of approximately 1500 m, with an accuracy of 2 cm-3 cm, and with support for a 1500 Mbps Ethernet connection, for example. In some examples, one or more non-protruding LIDAR sensors 1564 may be used. In such examples, the LIDAR sensor(s) 1564 may be implemented as a small device that may be embedded into the front, rear, sides, and/or corners of the vehicle 1500. The LIDAR sensor(s) 1564, in such examples, may provide up to a 120-degree horizontal and 35-degree vertical field-of-view, with a 200 m range even for low-reflectivity objects. Front-mounted LIDAR sensor(s) 1564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1564 may be less susceptible to motion blur, vibration, and/or shock.

The vehicle may further include IMU sensor(s) 1566. The IMU sensor(s) 1566 may be located at a center of the rear axle of the vehicle 1500, in some examples. The IMU sensor(s) 1566 may include, for example and without limitation, an accelerometer(s), a magnetometer(s), a gyroscope(s), a magnetic compass(es), and/or other sensor types. In some examples, such as in six-axis applications, the IMU sensor(s) 1566 may include accelerometers and gyroscopes, while in nine-axis applications, the IMU sensor(s) 1566 may include accelerometers, gyroscopes, and magnetometers.

In some embodiments, the IMU sensor(s) 1566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1566 may enable the vehicle 1500 to estimate heading without requiring input from a magnetic sensor by directly observing and correlating the changes in velocity from GPS to the IMU sensor(s) 1566. In some examples, the IMU sensor(s) 1566 and the GNSS sensor(s) 1558 may be combined in a single integrated unit.

The vehicle may include microphone(s) 1596 placed in and/or around the vehicle 1500. The microphone(s) 1596 may be used for emergency vehicle detection and identification, among other things.

The vehicle may further include any number of camera types, including stereo camera(s) 1568, wide-view camera(s) 1570, infrared camera(s) 1572, surround camera(s) 1574, long-range and/or mid-range camera(s) 1598, and/or other camera types. The cameras may be used to capture image data around an entire periphery of the vehicle 1500. The types of cameras used depends on the embodiments and requirements for the vehicle 1500, and any combination of camera types may be used to provide the necessary coverage around the vehicle 1500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 15A and FIG. 15B.

The vehicle 1500 may further include vibration sensor(s) 1542. The vibration sensor(s) 1542 may measure vibrations of components of the vehicle, such as the axle(s). For example, changes in vibrations may indicate a change in road surfaces. In another example, when two or more vibration sensors 1542 are used, the differences between the vibrations may be used to determine friction or slippage of the road surface (e.g., when the difference in vibration is between a power-driven axle and a freely rotating axle).

The vehicle 1500 may include an ADAS system 1538. The ADAS system 1538 may include a SoC, in some examples. The ADAS system 1538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1560, LIDAR sensor(s) 1564, and/or a camera(s). The ACC systems may include longitudinal ACC and/or lateral ACC. Longitudinal ACC monitors and controls the distance to the vehicle immediately ahead of the vehicle 1500 and automatically adjust the vehicle speed to maintain a safe distance from vehicles ahead. Lateral ACC performs distance keeping, and advises the vehicle 1500 to change lanes when necessary. Lateral ACC is related to other ADAS applications such as LCA and CWS.

CACC uses information from other vehicles that may be received via the network interface 1524 and/or the wireless antenna(s) 1526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1500), while the I2V communication concept provides information about traffic further ahead. CACC systems may include either or both I2V and V2V information sources. Given the information of the vehicles ahead of the vehicle 1500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1500 if the vehicle 1500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1500 is backing up. Some RCTW systems include AEB to ensure that the vehicle brakes are applied to avoid a crash. RCTW systems may use one or more rear-facing RADAR sensor(s) 1560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1500, the vehicle 1500 itself must, in the case of conflicting results, decide whether to heed the result from a primary computer or a secondary computer (e.g., a first controller 1536 or a second controller 1536). For example, in some embodiments, the ADAS system 1538 may be a backup and/or secondary computer for providing perception information to a backup computer rationality module. The backup computer rationality monitor may run a redundant diverse software on hardware components to detect faults in perception and dynamic driving tasks. Outputs from the ADAS system 1538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1504.

In other examples, ADAS system 1538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1538 may be fed into the primary computer's perception block and/or the primary computer's dynamic driving task block. For example, if the ADAS system 1538 indicates a forward crash warning due to an object immediately ahead, the perception block may use this information when identifying objects. In other examples, the secondary computer may have its own neural network which is trained and thus reduces the risk of false positives, as described herein.

The vehicle 1500 may further include the infotainment SoC 1530 (e.g., an in-vehicle infotainment system (IVI)). Although illustrated and described as a SoC, the infotainment system may not be a SoC, and may include two or more discrete components. The infotainment SoC 1530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1500. For example, the infotainment SoC 1530 may radios, disk players, navigation systems, video players, USB and Bluetooth connectivity, carputers, in-car entertainment, Wi-Fi, steering wheel audio controls, hands free voice control, a heads-up display (HUD), an HMI display 1534, a telematics device, a control panel (e.g., for controlling and/or interacting with various components, features, and/or systems), and/or other components. The infotainment SoC 1530 may further be used to provide information (e.g., visual and/or audible) to a user(s) of the vehicle, such as information from the ADAS system 1538, autonomous driving information such as planned vehicle maneuvers, trajectories, surrounding environment information (e.g., intersection information, vehicle information, road information, etc.), and/or other information.

The infotainment SoC 1530 may include GPU functionality. The infotainment SoC 1530 may communicate over the bus 1502 (e.g., CAN bus, Ethernet, etc.) with other devices, systems, and/or components of the vehicle 1500. In some examples, the infotainment SoC 1530 may be coupled to a supervisory MCU such that the GPU of the infotainment system may perform some self-driving functions in the event that the primary controller(s) 1536 (e.g., the primary and/or backup computers of the vehicle 1500) fail. In such an example, the infotainment SoC 1530 may put the vehicle 1500 into a chauffeur to safe stop mode, as described herein.

The vehicle 1500 may further include an instrument cluster 1532 (e.g., a digital dash, an electronic instrument cluster, a digital instrument panel, etc.). The instrument cluster 1532 may include a controller and/or supercomputer (e.g., a discrete controller or supercomputer). The instrument cluster 1532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1530 and the instrument cluster 1532. In other words, the instrument cluster 1532 may be included as part of the infotainment SoC 1530, or vice versa.

FIG. 15D is a system diagram for communication between cloud-based server(s) and the example autonomous vehicle 1500 of FIG. 15A, in accordance with some embodiments of the present disclosure. The system 1576 may include server(s) 1578, network(s) 1590, and vehicles, including the vehicle 1500. The server(s) 1578 may include a plurality of GPUs 1584(A)-1584(H) (collectively referred to herein as GPUs 1584), PCIe switches 1582(A)-1582(H) (collectively referred to herein as PCIe switches 1582), and/or CPUs 1580(A)-1580(B) (collectively referred to herein as CPUs 1580). The GPUs 1584, the CPUs 1580, and the PCIe switches may be interconnected with high-speed interconnects such as, for example and without limitation, NVLink interfaces 1588 developed by NVIDIA and/or PCIe connections 1586. In some examples, the GPUs 1584 are connected via NVLink and/or NVSwitch SoC and the GPUs 1584 and the PCIe switches 1582 are connected via PCIe interconnects. Although eight GPUs 1584, two CPUs 1580, and two PCIe switches are illustrated, this is not intended to be limiting. Depending on the embodiment, each of the server(s) 1578 may include any number of GPUs 1584, CPUs 1580, and/or PCIe switches. For example, the server(s) 1578 may each include eight, sixteen, thirty-two, and/or more GPUs 1584.

The server(s) 1578 may receive, over the network(s) 1590 and from the vehicles, image data representative of images showing unexpected or changed road conditions, such as recently commenced road-work. The server(s) 1578 may transmit, over the network(s) 1590 and to the vehicles, neural networks 1592, updated neural networks 1592, and/or map information 1594, including information regarding traffic and road conditions. The updates to the map information 1594 may include updates for the HD map 1522, such as information regarding construction sites, potholes, detours, flooding, and/or other obstructions. In some examples, the neural networks 1592, the updated neural networks 1592, and/or the map information 1594 may have resulted from new training and/or experiences represented in data received from any number of vehicles in the environment, and/or based on training performed at a datacenter (e.g., using the server(s) 1578 and/or other servers).

The server(s) 1578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1590, and/or the machine learning models may be used by the server(s) 1578 to remotely monitor the vehicles.

In some examples, the server(s) 1578 may receive data from the vehicles and apply the data to up-to-date real-time neural networks for real-time intelligent inferencing. The server(s) 1578 may include deep-learning supercomputers and/or dedicated AI computers powered by GPU(s) 1584, such as a DGX and DGX Station machines developed by NVIDIA. However, in some examples, the server(s) 1578 may include deep learning infrastructure that use only CPU-powered datacenters.

The deep-learning infrastructure of the server(s) 1578 may be capable of fast, real-time inferencing, and may use that capability to evaluate and verify the health of the processors, software, and/or associated hardware in the vehicle 1500. For example, the deep-learning infrastructure may receive periodic updates from the vehicle 1500, such as a sequence of images and/or objects that the vehicle 1500 has located in that sequence of images (e.g., via computer vision and/or other machine learning object classification techniques). The deep-learning infrastructure may run its own neural network to identify the objects and compare them with the objects identified by the vehicle 1500 and, if the results do not match and the infrastructure concludes that the AI in the vehicle 1500 is malfunctioning, the server(s) 1578 may transmit a signal to the vehicle 1500 instructing a fail-safe computer of the vehicle 1500 to assume control, notify the passengers, and complete a safe parking maneuver.

For inferencing, the server(s) 1578 may include the GPU(s) 1584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 16 is a block diagram of an example computing device(s) 1600 suitable for use in implementing some embodiments of the present disclosure. Computing device 1600 may include an interconnect system 1602 that directly or indirectly couples the following devices: memory 1604, one or more central processing units (CPUs) 1606, one or more graphics processing units (GPUs) 1608, a communication interface 1610, input/output (I/O) ports 1612, input/output components 1614, a power supply 1616, one or more presentation components 1618 (e.g., display(s)), and one or more logic units 1620. In at least one embodiment, the computing device(s) 1600 may comprise one or more virtual machines (VMs), and/or any of the components thereof may comprise virtual components (e.g., virtual hardware components). For non-limiting examples, one or more of the GPUs 1608 may comprise one or more vGPUs, one or more of the CPUs 1606 may comprise one or more vCPUs, and/or one or more of the logic units 1620 may comprise one or more virtual logic units. As such, a computing device(s) 1600 may include discrete components (e.g., a full GPU dedicated to the computing device 1600), virtual components (e.g., a portion of a GPU dedicated to the computing device 1600), or a combination thereof.

Although the various blocks of FIG. 16 are shown as connected via the interconnect system 1602 with lines, this is not intended to be limiting and is for clarity only. For example, in some embodiments, a presentation component 1618, such as a display device, may be considered an I/O component 1614 (e.g., if the display is a touch screen). As another example, the CPUs 1606 and/or GPUs 1608 may include memory (e.g., the memory 1604 may be representative of a storage device in addition to the memory of the GPUs 1608, the CPUs 1606, and/or other components). In other words, the computing device of FIG. 16 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 16.

The interconnect system 1602 may represent one or more links or busses, such as an address bus, a data bus, a control bus, or a combination thereof. The interconnect system 1602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1606 may be directly connected to the memory 1604. Further, the CPU 1606 may be directly connected to the GPU 1608. Where there is direct, or point-to-point connection between components, the interconnect system 1602 may include a PCIe link to carry out the connection. In these examples, a PCI bus need not be included in the computing device 1600.

The memory 1604 may include any of a variety of computer-readable media. The computer-readable media may be any available media that may be accessed by the computing device 1600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1606 may be configured to execute at least some of the computer-readable instructions to control one or more components of the computing device 1600 to perform one or more of the methods and/or processes described herein. The CPU(s) 1606 may each include one or more cores (e.g., one, two, four, eight, twenty-eight, seventy-two, etc.) that are capable of handling a multitude of software threads simultaneously. The CPU(s) 1606 may include any type of processor, and may include different types of processors depending on the type of computing device 1600 implemented (e.g., processors with fewer cores for mobile devices and processors with more cores for servers). For example, depending on the type of computing device 1600, the processor may be an Advanced RISC Machines (ARM) processor implemented using Reduced Instruction Set Computing (RISC) or an x86 processor implemented using Complex Instruction Set Computing (CISC). The computing device 1600 may include one or more CPUs 1606 in addition to one or more microprocessors or supplementary co-processors, such as math co-processors.

In addition to or alternatively from the CPU(s) 1606, the GPU(s) 1608 may be configured to execute at least some of the computer-readable instructions to control one or more components of the computing device 1600 to perform one or more of the methods and/or processes described herein. One or more of the GPU(s) 1608 may be an integrated GPU (e.g., with one or more of the CPU(s) 1606 and/or one or more of the GPU(s) 1608 may be a discrete GPU. In embodiments, one or more of the GPU(s) 1608 may be a coprocessor of one or more of the CPU(s) 1606. The GPU(s) 1608 may be used by the computing device 1600 to render graphics (e.g., 3D graphics) or perform general purpose computations. For example, the GPU(s) 1608 may be used for General-Purpose computing on GPUs (GPGPU). The GPU(s) 1608 may include hundreds or thousands of cores that are capable of handling hundreds or thousands of software threads simultaneously. The GPU(s) 1608 may generate pixel data for output images in response to rendering commands (e.g., rendering commands from the CPU(s) 1606 received via a host interface). The GPU(s) 1608 may include graphics memory, such as display memory, for storing pixel data or any other suitable data, such as GPGPU data. The display memory may be included as part of the memory 1604. The GPU(s) 1608 may include two or more GPUs operating in parallel (e.g., via a link). The link may directly connect the GPUs (e.g., using NVLINK) or may connect the GPUs through a switch (e.g., using NVSwitch). When combined together, each GPU 1608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1606 and/or the GPU(s) 1608, the logic unit(s) 1620 may be configured to execute at least some of the computer-readable instructions to control one or more components of the computing device 1600 to perform one or more of the methods and/or processes described herein. In embodiments, the CPU(s) 1606, the GPU(s) 1608, and/or the logic unit(s) 1620 may discretely or jointly perform any combination of the methods, processes and/or portions thereof. One or more of the logic units 1620 may be part of and/or integrated in one or more of the CPU(s) 1606 and/or the GPU(s) 1608 and/or one or more of the logic units 1620 may be discrete components or otherwise external to the CPU(s) 1606 and/or the GPU(s) 1608. In embodiments, one or more of the logic units 1620 may be a coprocessor of one or more of the CPU(s) 1606 and/or one or more of the GPU(s) 1608.

Examples of the logic unit(s) 1620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1610 may include one or more receivers, transmitters, and/or transceivers that enable the computing device 1600 to communicate with other computing devices via an electronic communication network, included wired and/or wireless communications. The communication interface 1610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1620 and/or communication interface 1610 may include one or more data processing units (DPUs) to transmit data received over a network and/or through interconnect system 1602 directly to (e.g., a memory of) one or more GPU(s) 1608.

The I/O ports 1612 may enable the computing device 1600 to be logically coupled to other devices including the I/O components 1614, the presentation component(s) 1618, and/or other components, some of which may be built in to (e.g., integrated in) the computing device 1600. Illustrative I/O components 1614 include a microphone, mouse, keyboard, joystick, game pad, game controller, satellite dish, scanner, printer, wireless device, etc. The I/O components 1614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1600. The computing device 1600 may be include depth cameras, such as stereoscopic camera systems, infrared camera systems, RGB camera systems, touchscreen technology, and combinations of these, for gesture detection and recognition. Additionally, the computing device 1600 may include accelerometers or gyroscopes (e.g., as part of an inertia measurement unit (IMU)) that enable detection of motion. In some examples, the output of the accelerometers or gyroscopes may be used by the computing device 1600 to render immersive augmented reality or virtual reality.

The power supply 1616 may include a hard-wired power supply, a battery power supply, or a combination thereof. The power supply 1616 may provide power to the computing device 1600 to enable the components of the computing device 1600 to operate.

The presentation component(s) 1618 may include a display (e.g., a monitor, a touch screen, a television screen, a heads-up-display (HUD), other display types, or a combination thereof), speakers, and/or other presentation components. The presentation component(s) 1618 may receive data from other components (e.g., the GPU(s) 1608, the CPU(s) 1606, DPUs, etc.), and output the data (e.g., as an image, video, sound, etc.).

### Example Data Center

FIG. 17 illustrates an example data center 1700 that may be used in at least one embodiments of the present disclosure. The data center 1700 may include a data center infrastructure layer 1710, a framework layer 1720, a software layer 1730, and/or an application layer 1740.

As shown in FIG. 17, the data center infrastructure layer 1710 may include a resource orchestrator 1712, grouped computing resources 1714, and node computing resources (“node C.R.s”) 1716(1)-1716(N), where “N” represents any whole, positive integer. In at least one embodiment, node C.R.s 1716(1)-1716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1716(1)-1716(N) may correspond to a server having one or more of the above-mentioned computing resources. In addition, in some embodiments, the node C.R.s 1716(1)-17161(N) may include one or more virtual components, such as vGPUs, vCPUs, and/or the like, and/or one or more of the node C.R.s 1716(1)-1716(N) may correspond to a virtual machine (VM).

In at least one embodiment, grouped computing resources 1714 may include separate groupings of node C.R.s 1716 housed within one or more racks (not shown), or many racks housed in data centers at various geographical locations (also not shown). Separate groupings of node C.R.s 1716 within grouped computing resources 1714 may include grouped compute, network, memory or storage resources that may be configured or allocated to support one or more workloads. In at least one embodiment, several node C.R.s 1716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1712 may configure or otherwise control one or more node C.R.s 1716(1)-1716(N) and/or grouped computing resources 1714. In at least one embodiment, resource orchestrator 1712 may include a software design infrastructure (SDI) management entity for the data center 1700. The resource orchestrator 1712 may include hardware, software, or some combination thereof.

In at least one embodiment, as shown in FIG. 17, framework layer 1720 may include a job scheduler 1733, a configuration manager 1734, a resource manager 1736, and/or a distributed file system 1738. The framework layer 1720 may include a framework to support software 1732 of software layer 1730 and/or one or more application(s) 1742 of application layer 1740. The software 1732 or application(s) 1742 may respectively include web-based service software or applications, such as those provided by Amazon Web Services, Google Cloud and Microsoft Azure. The framework layer 1720 may be, but is not limited to, a type of free and open-source software web application framework such as Apache Spark™ (hereinafter “Spark”) that may utilize distributed file system 1738 for large-scale data processing (e.g., “big data”). In at least one embodiment, job scheduler 1733 may include a Spark driver to facilitate scheduling of workloads supported by various layers of data center 1700. The configuration manager 1734 may be capable of configuring different layers such as software layer 1730 and framework layer 1720 including Spark and distributed file system 1738 for supporting large-scale data processing. The resource manager 1736 may be capable of managing clustered or grouped computing resources mapped to or allocated for support of distributed file system 1738 and job scheduler 1733. In at least one embodiment, clustered or grouped computing resources may include grouped computing resource 1714 at data center infrastructure layer 1710. The resource manager 1736 may coordinate with resource orchestrator 1712 to manage these mapped or allocated computing resources.

In at least one embodiment, software 1732 included in software layer 1730 may include software used by at least portions of node C.R.s 1716(1)-1716(N), grouped computing resources 1714, and/or distributed file system 1738 of framework layer 1720. One or more types of software may include, but are not limited to, Internet web page search software, e-mail virus scan software, database software, and streaming video content software.

In at least one embodiment, application(s) 1742 included in application layer 1740 may include one or more types of applications used by at least portions of node C.R.s 1716(1)-1716(N), grouped computing resources 1714, and/or distributed file system 1738 of framework layer 1720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1734, resource manager 1736, and resource orchestrator 1712 may implement any number and type of self-modifying actions based on any amount and type of data acquired in any technically feasible fashion. Self-modifying actions may relieve a data center operator of data center 1700 from making possibly bad configuration decisions and possibly avoiding underutilized and/or poor performing portions of a data center.

The data center 1700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1700. In at least one embodiment, trained or deployed machine learning models corresponding to one or more neural networks may be used to infer or predict information using resources described above with respect to the data center 1700 by using weight parameters calculated through one or more training techniques, such as but not limited to those described herein.

In at least one embodiment, the data center 1700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1600 of FIG. 16—e.g., each device may include similar components, features, and/or functionality of the computing device(s) 1600. In addition, where backend devices (e.g., servers, NAS, etc.) are implemented, the backend devices may be included as part of a data center 1700, an example of which is described in more detail herein with respect to FIG. 17.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1600 described herein with respect to FIG. 16. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
one or more processing units to:
determine that an image, represented by first image data generated using one or more first sensors of a machine, is associated with a time;
determine, based at least on the time, a portion of second image data that is generated using one or more second sensors of the machine;
generate, based at least on the portion of the second image data, map data representative of one or more locations associated with one or more objects; and
generate, based at least on the map data, at least one annotation associated with an object, of the one or more objects, depicted by the image.

2. The system of claim 1, wherein:
the second sensor data corresponds to a point cloud;
the one or more second sensors comprise one or more LiDAR sensors; and
the determination of the portion of the point cloud comprises:
determining a first portion of the point cloud that is associated with a spin of the one or more LiDAR sensors that occurred proximate to the time; and
determining a second portion of the point cloud that is associated with one or more spins that occurred at least one of before the spin or after the spin, the portion of the point cloud including the first portion of the point cloud and the second portion of the point cloud.

3. The system of claim 1, wherein the one or more processing units are further to:
determine, based at least on one or more parameters associated with the one or more first sensors, a portion of the map data that is associated with the image,
wherein the generation of the at least one annotation is further based at least on the portion of the map data.

4. The system of claim 1, wherein the one or more processing units are further to:
Project, based at least on the map data, one or more points associated with the object onto the image,
Wherein the generation of the at least one annotation is based at least on the projection of the one or more points.

5. The system of claim 1, wherein the one or more processing units are further to determine, based at least on the map data, one or more depth values associated with the object.

6. The system of claim 5, wherein the one or more processing units are further to:
determine, based at least on the map data, one or more second depth values associated with a second object depicted by the image; and
determine, based at least on the one or more depth values associated with the object and the one or more second depth values associated with the second object, that one of:
the object is at least partially occluded by the second object; or
the second object is at least partially occluded by the object.

7. The system of claim 1, wherein:
the one or more first sensors include a first rolling shutter that is associated with a first time period;
the one or more second sensors include a second rolling shutter that is associated with a second time period; and
the determination of the portion of the second sensor data is further based at least on the first time period and the second time period.

8. The system of claim 1, wherein the one or more processing units are further to:
determine, based at least on the map data, one or more first depth values associated with the object;
determine, based at least on the first sensor data, that a portion of the image depicts the object; and
determine, based at least on the one or more first depth values and the portion of the image, one or more second depth values associated with the object.

9. The system of claim 8, wherein:
the one or more first sensors are associated with a first resolution;
the one or more second sensors are associated with a second resolution; and
the determination of the one or more second depth values associated with the object occurs based at least on first resolution being greater than the second resolution.

10. The system of claim 1, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

11. A method comprising:
generating, based at least on first sensor data generated using one or more first sensors of a machine, map data representing one or more first locations of one or more static objects and one or more second locations of one or more dynamic objects;
determining, based at least on second sensor data generated using one or more second sensors of the machine, that an image represented by the second sensor data is associated with a portion of the map data; and
generating, based at least on the portion of the map data, at least one annotation associated with a dynamic object, of the one or more dynamic objects, depicted by the image.

12. The method of claim 11, further comprising:
determining a time that the second sensor data was generated by the one or more second sensors; and
determining that the map is associated with the time,
wherein the generating the at least one annotation is further based at least on the map data being associated with the time.

13. The method of claim 11, wherein:
the one or more second locations of the one or more dynamic objects are associated with a first time;
the map data further represents one or more third locations of the one or more dynamic objects, the one or more third locations associated with a second time; and
the method further comprises:
determining a third time that the second sensor data was generated by the one or more second sensors; and
determining to annotate the image using the one or more second locations of the one or more dynamic objects based at least on the first time, the second time, and the third time.

14. The method of claim 11, further comprising:
determining a location associated with the machine when the second sensor data was generated using the one or more second sensors,
wherein the determining that the image is associated with the portion of the map data is further based at least on the location associated with the machine.

15. The method of claim 11, further comprising determining, based at least on the portion of the map data, one or more depth values associated with the dynamic object.

16. The method of claim 15, further comprising:
determining, based at least on the portion of the map data, one or more second depth values associated with an object depicted by the image, the object including one of the one or more static objects or the one or more dynamic objects; and
determining, based at least on the one or more depth values associated with the dynamic object and the one or more second depth values associated with the object, that one of:
the dynamic object is at least partially occluded by the object; or
the object is at least partially occluded by the dynamic object.

17. The method of claim 11, wherein:
the one or more first sensors include a first rolling shutter that is associated with a first time period;
the one or more second sensors include a second rolling shutter that is associated with a second time period; and
the determining the at least one annotation associated with the dynamic object is further based at least on the first time period and the second time period.

18. The method of claim 11, further comprising:
determining, based at least on the portion of the map data, one or more first depth values associated with the dynamic object;
determining, based at least on the second sensor data, that a portion of the image depicts the dynamic object; and
determining, based at least on the one or more first depth values and the portion of the image, one or more second depth values associated with the dynamic object.

19. A processor comprising:
one or more processing units to generate, based at least on a portion of map data, an annotation associated with a dynamic object depicted by an image represented by first sensor data generated using one or more first sensors of a machine, wherein the map data is associated with second sensor data generated using one or more second sensors of the machine and represents at least a location of the dynamic object at a point in time.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
